(19) United States
(12) Patent Application Publication
(10) Pub. No.: US 2026/0203519 A1
(43) Pub. Date: Jul. 16, 2026

(54) Temporal Pulse Regulation for Cognitive Systems

(71) Applicant: AtomBeam Technologies Inc., Moraga, CA (US)

(72) Inventors: Brian Galvin, Silverdale, WA (US); Alexandria Tucker, Urbana, IL (US)

(21) Appl. No.: 19/546,414

(22) Filed: Feb. 22, 2026

Related U.S. Application Data
(63) Continuation-in-part of application No. 19/451,299, filed on Jan. 16, 2026.
Application No. 19/451,299 is a continuation-in-part of application No. 19/443,014, filed on Jan. 7, 2026.
Application No. 19/443,014 is a continuation-in-part of application No. 19/422,420, filed on Dec. 16, 2025.
Application No. 19/422,420 is a continuation-in-part of application No. 19/397,852, filed on Nov. 21, 2025.
Application No. 19/397,852 is a continuation-in-part of application No. 19/390,475, filed on Nov. 14, 2025.
Application No. 19/390,475 is a continuation-in-part of application No. 19/329,546, filed on Sep. 15, 2025.
Application No. 19/329,546 is a continuation-in-part of application No. 19/328,206, filed on Sep. 14, 2025.
Application No. 19/328,206 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
Application No. 19/329,546 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/329,546 is a continuation-in-part of application No. 19/245,366, filed on Jun. 22, 2025, now Pat. No. 12,418,680.
Application No. 19/245,366 is a continuation-in-part of application No. 19/076,924, filed on Mar. 11, 2025.
Application No. 19/076,924 is a continuation-in-part of application No. 19/054,759, filed on Feb. 14, 2025.
Application No. 19/054,759 is a continuation-in-part of application No. 19/044,546, filed on Feb. 3, 2025.
Application No. 19/076,924 is a continuation-in-part of application No. 19/051,193, filed on Feb. 12, 2025, now Pat. No. 12,387,050.
(63) Continuation-in-part of application No. 19/412,842, filed on Dec. 8, 2025.
Application No. 19/412,842 is a continuation-in-part of application No. 19/392,134, filed on Nov. 18, 2025.
Application No. 19/392,134 is a continuation-in-part of application No. 19/203,069, filed on Jun. 3, 2025, now Pat. No. 12,481,688.
(60) Provisional application No. 63/651,359, filed on May 23, 2024.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/868,326, filed on Aug. 21, 2025.
(60) Provisional application No. 63/879,578, filed on Sep. 10, 2025.
(60) Provisional application No. 63/882,964, filed on Sep. 16, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for regulating temporal activity in persistent cognitive machines using intrinsic pulse mechanisms rather than external clocks. The system defines cognitive fields over a cognitive manifold stored in memory, where each field represents a distribution of cognitive state across the manifold. Temporal pulses are generated to authorize bounded execution intervals during which cognitive field updates occur, with each pulse corresponding to a discrete evolution step that advances the fields. A closed-loop control system monitors cognitive order parameters derived from the fields and adjusts pulse characteristics when deviations from a stability corridor are detected. Field updates are executed during authorized pulse intervals by applying update operators that modify values on the cognitive manifold. Completion of each pulse advances a cognitive time coordinate that operates independently of wall-clock time, enabling adaptive pacing and persistent cognition across varying computational conditions.

### CROSS-REFERENCE TO RELATED APPLICATIONS

Priority is claimed in the application data sheet to the following patents or patent applications, each of which is expressly incorporated herein by reference in its entirety:
Ser. No. 19/451,299
Ser. No. 19/443,014
Ser. No. 19/422,420
Ser. No. 19/397,852
Ser. No. 19/390,475
Ser. No. 19/329,546
Ser. No. 19/328,206
63/868,326
Ser. No. 19/203,069
Ser. No. 19/412,842
Ser. No. 19/392,134
Ser. No. 63/882,964
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359
Ser. No. 63/879,578
Ser. No. 19/328,094
Ser. No. 19/321,173
Ser. No. 19/284,115
Ser. No. 19/051,193
63/847,082
63/847,091
63/847,096
63/847,101
Ser. No. 19/245,366
Ser. No. 19/076,924
Ser. No. 19/054,759

### BACKGROUND OF THE INVENTION

### Field of the Art

The present invention relates to the field of artificial intelligence and cognitive computing systems, and more specifically to systems and methods for intrinsically regulating temporal execution in persistent cognitive machines using internally generated and feedback-controlled temporal pulses.

### Discussion of the State of the Art

Contemporary artificial intelligence and cognitive computing systems predominantly rely on externally imposed timing mechanisms to govern computation. Such systems are typically driven by operating system clocks, fixed scheduling quanta, batch execution cycles, or hardware interrupt mechanisms that are fundamentally exogenous to the cognitive processes being executed. In these architectures, the progression of computation is dictated by wall-clock time, processor availability, or externally defined execution loops, rather than by the internal state, stability, or coherence of the cognitive system itself.

Large-scale machine learning systems, including neural networks and large language models, are generally executed in discrete inference or training steps that are synchronized to external schedulers. These systems process information in fixed or preconfigured cycles regardless of whether the internal cognitive representation is stable, unstable, converging, or oscillatory. While such externally clocked execution models are adequate for short-lived inference tasks or stateless prediction, they exhibit significant limitations when applied to persistent or long-running cognitive systems that must operate continuously over extended periods.

Multi-agent systems and distributed cognitive architectures similarly depend on externally coordinated timing, synchronization barriers, or message-passing schedules to regulate interaction among components. As system scale increases, these approaches introduce coordination overhead, synchronization bottlenecks, and instability arising from misaligned execution rates across agents or subsystems. Moreover, externally enforced timing does not adapt naturally to variations in cognitive demand, uncertainty, or internal state evolution, leading either to wasted computation during quiescent periods or to runaway activity during periods of instability.

More advanced cognitive architectures have begun to model cognition as the evolution of internal state over structured representations, such as graphs, manifolds, or latent fields. These approaches recognize that cognition is not merely a sequence of discrete symbolic operations but rather a continuous or quasi-continuous process involving propagation, integration, and consolidation of cognitive state. However, even in these systems, the temporal dimension is typically treated as an implicit parameter tied to external execution schedules rather than as a first-class, regulated component of cognition. As a result, such systems remain vulnerable to temporal pathologies including starvation, over-excitation, desynchronization, and loss of coherence, particularly in persistent deployments.

In addition, accelerator-based implementations, such as those utilizing GPUs or other parallel hardware, further exacerbate these issues by introducing variability in execution latency, thermal constraints, and resource contention. When kernel execution is driven solely by external scheduling policies, cognitive processes may become misaligned with the internal dynamics they are intended to model or regulate. This mismatch undermines stability, efficiency, and interpretability in long-running cognitive systems.

Accordingly, the state of the art lacks a principled mechanism by which cognitive systems can regulate their own temporal progression based on internal cognitive state, stability, and coherence, rather than relying on external clocks or schedulers. Existing approaches do not provide a unified framework in which time itself is treated as an intrinsic, regulated cognitive variable that governs when and how cognitive state is permitted to evolve.

What is needed is a cognitive system architecture in which temporal activity is governed by internally generated and regulated temporal pulses that authorize bounded execution intervals based on internal cognitive state, that adapt dynamically through closed-loop control using cognitive order parameters, and that advance an internal cognitive time coordinate decoupled from wall-clock time, thereby enabling stable, persistent, and scalable cognition across diverse hardware and deployment environments.

### SUMMARY OF THE INVENTION

Accordingly, the inventor has conceived and reduced to practice a computer system for regulating cognitive activity in persistent cognitive machines by treating time as an intrinsic, internally regulated construct rather than as an externally imposed clock. The disclosed system governs when and how cognitive computation occurs by generating internally controlled temporal pulses that authorize bounded execution intervals, during which cognitive state evolves on a cognitive manifold. By regulating pulse generation through closed-loop feedback derived from internal cognitive state, the system maintains coherent, stable, and persistent cognition while remaining decoupled from wall-clock or operating-system timing, thereby enabling scalable, hardware-aware, and long-running cognitive operation.

In an embodiment, a computer system executes software instructions that define one or more cognitive fields over a cognitive manifold represented in hardware memory, where each cognitive field encodes a distribution of cognitive state across positions on the manifold. In this embodiment, the computer system generates temporal pulses that authorize bounded execution intervals during which cognitive field updates are permitted to be performed, with each temporal pulse corresponding to a discrete evolution step that advances the cognitive fields on the cognitive manifold. Pulse generation is regulated by a closed-loop control system that monitors cognitive order parameters derived from the cognitive fields and adjusts pulse characteristics based on deviations from a stability corridor defined in a space of those order parameters. Cognitive field updates are executed only during authorized pulse intervals by applying update operators that modify field values or field relationships on the cognitive manifold, and completion of each pulse advances an internal cognitive time coordinate that is decoupled from wall-clock or operating-system time.

In an aspect of an embodiment, the temporal pulses are organized into a plurality of pulse bands operating at distinct characteristic frequencies, where each pulse band serves a different cognitive function and the pulse bands operate hierarchically such that higher-frequency bands are nested within lower-frequency bands.

In an aspect of an embodiment, the cognitive order parameters monitored by the closed-loop control system include one or more measures of phase coherence that reflect alignment of activity across regions of the cognitive manifold, spectral entropy that reflects dispersion of activity across pulse frequencies, or field-energy variation that reflects magnitude of change in the cognitive fields between successive pulses.

In an aspect of an embodiment, the closed-loop control system detects temporal pathologies that degrade cognitive coherence, including pulse starvation in which pulse activity falls below a threshold required to sustain cognitive continuity, pulse storm in which pulses are generated at excessive frequency, or temporal desynchronization in which pulse phases across regions of the cognitive manifold lose alignment, and initiates recovery protocols that restore stable operation.

In an aspect of an embodiment, the cognitive manifold is represented as a graph structure comprising nodes corresponding to localized regions of cognitive state and edges encoding relationships between those regions, and temporal pulses propagate as wavefronts across subsets of nodes and edges with attenuation controlled by damping coefficients.

In an aspect of an embodiment, the update operators are executed on one or more hardware accelerators, with each temporal pulse corresponding to a bounded execution interval during which accelerator kernels are launched, such that kernel completion constitutes pulse completion and successive kernel launches advance the cognitive time coordinate.

In an aspect of an embodiment, the closed-loop control system incorporates hardware feedback signals, including utilization metrics or thermal status from the hardware accelerators, and adjusts pulse characteristics to maintain hardware safety while preserving cognitive continuity.

In an aspect of an embodiment, the computer system operates as one node in a distributed configuration comprising a plurality of nodes, with each node maintaining local pulse regulation based on local cognitive state while exchanging synchronization signals with other nodes, the synchronization signals including pulse phase indicators or field-energy proxies that enable federated alignment of the cognitive time coordinate without reliance on a centralized clock.

In an aspect of an embodiment, the software instructions further enforce a refractory interval defining a minimum separation between successive pulses, thereby preventing excessive pulse generation and allowing the cognitive fields to stabilize between updates.

Method embodiments corresponding to the foregoing computer system embodiments apply equally to the disclosed subject matter and implement the same operations and variations using computer-implemented methods, although such method embodiments are not restated separately herein.

### BRIEF DESCRIPTION OF THE DRAWING FIGURES

FIG. 1 is a block diagram illustrating an exemplary system architecture for temporal pulse regulation in a persistent cognitive machine, showing interactions among core subsystems.

FIG. 2 is a block diagram illustrating a temporal pulse generator configured to emit pulse bands with distinct cognitive functions and manage cadence, phase, and wavefront propagation.

FIG. 3 is a block diagram illustrating a closed-loop control system configured to compute cognitive order parameters and generate control actions that regulate pulse behavior.

FIG. 4 is a block diagram illustrating a pathology detection and recovery system configured to identify temporal pathologies and initiate corrective protocols.

FIG. 5 is a block diagram illustrating a cognitive manifold substrate comprising a graph-structured manifold with typed latent fields and support for pulse wavefront traversal.

FIG. 6 is a block diagram illustrating a field evolution engine configured to execute field updates using discrete operators and enforce conservation constraints.

FIG. 7 is a block diagram illustrating a distributed synchronization controller configured to coordinate pulse regulation across nodes using synchronization signals and trust-weighted adjustments.

FIG. 8 is a block diagram illustrating a subsystem integration layer configured to coordinate pulse-gated access to other cognitive subsystems including reasoning, caching, and persistence layers.

FIG. 9 is a flow diagram illustrating a method for temporal pulse regulation in which pulses are generated, evaluated, and adjusted based on internal cognitive state.

FIG. 10 is a flow diagram illustrating a closed-loop pulse regulation cycle in which cognitive order parameters are computed and used to drive adaptive control of pulse parameters.

FIG. 11 is a flow diagram illustrating pathology detection and recovery, including classification of pulse starvation, storm, or desynchronization and execution of corresponding recovery protocols.

FIG. 12 is a flow diagram illustrating pulse-gated field evolution on a graph-structured manifold, including wavefront propagation, field update execution, and constraint enforcement.

FIG. 13 is a flow diagram illustrating distributed synchronization across nodes, including signal exchange, diffusion, federated stability evaluation, and alignment of local pulse behavior.

FIG. 14 illustrates an exemplary computing environment on which an embodiment described herein may be implemented.

### DETAILED DESCRIPTION OF THE INVENTION

The inventor has conceived and reduced to practice a system and method for regulating temporal activity in a cognitive computing system by treating time as an intrinsic, internally governed aspect of cognition rather than as an externally imposed execution parameter. Conventional artificial intelligence systems rely on externally imposed scheduling mechanisms, including operating system clocks, batch schedulers, and fixed inference cycles, to govern computation. Such mechanisms are fundamentally exogenous to cognition and do not adapt to the internal state, stability, or coherence of the cognitive process itself, creating inefficiencies, brittle behavior, and pathological failure modes in long-running or autonomous systems. The disclosed system addresses these limitations by advancing cognitive activity through internally generated temporal pulses that authorize bounded execution intervals during which cognitive state evolves on a cognitive manifold. Temporal pulses are generated, modulated, and suppressed based on internal cognitive state, stability metrics, and feedback control, enabling persistent, coherent, and long-running cognition that is decoupled from wall-clock or operating-system time.

A computer system executes software instructions stored on nontransitory machine-readable storage media, wherein the instructions define one or more cognitive fields over a cognitive manifold represented in hardware memory. The cognitive manifold provides a structured state space in which cognitive content is encoded and evolves. Cognitive state is represented not as isolated symbols or static vectors, but as distributions over positions within the manifold. Each cognitive field encodes a distribution, intensity, or influence of a particular cognitive type across the manifold, such as factual anchors, uncertainty measures, reasoning trajectories, or invariant constraints. Field values vary continuously or discretely across manifold positions and collectively define the instantaneous cognitive configuration of the system.

The cognitive manifold may be represented digitally as a graph structure comprising nodes corresponding to localized regions of cognitive state and edges encoding relationships such as semantic adjacency, transition likelihood, or structural affinity. Field values are associated with nodes and may propagate across edges according to update operators. In distributed configurations, a graph may be partitioned into subgraphs such that each partition maintains local cognitive state while preserving boundary connectivity information used for coordination with other partitions.

Cognitive evolution proceeds through application of update operators that transform field state over time. Continuous evolution of cognitive fields is approximated through discrete update steps, with each update step corresponding to a temporal pulse. During an authorized execution interval, current field values are read from memory, one or more update operators are applied, and updated values are committed back to the cognitive manifold representation. Update operators may include diffusion or graph Laplacian operators that propagate values across edges with controlled damping, neighborhood aggregation operators that compute local summaries, cross-type coupling operators that enable interaction among different cognitive fields, or spectral operators that analyze frequency-domain properties of field activity.

In some implementations, field evolution is treated as a discrete approximation of continuous dynamical flow. For example, cognitive state evolution on a manifold may be described in terms of trajectories that follow geodesic paths through semantic space, where a trajectory γ(τ) evolves according to relationships such as

$$( {d}^{2} {m}_{u} ) / ( d {τ}^{2} ) + {Γ}_{u v r} ( d {m}_{v} / d τ ) ( d {m}_{r} / d τ ) = 0 ,$$

with Γᵤᵥᵣ representing connection coefficients that encode the geometry of meaning. Temporal pulses correspond to bounded increments of the parameter t, such that each pulse advances cognition by a controlled amount along these trajectories.

Temporal pulses are generated internally rather than derived from external clocks. A temporal pulse defines a bounded execution interval during which cognitive field updates are permitted to occur. Pulse initiation, duration, and termination are determined by internal cognitive state rather than elapsed physical time. Completion of a pulse constitutes completion of a discrete cognitive evolution step and advances an internal cognitive time coordinate. Cognitive time progresses as a function of pulse completion rather than wall-clock progression, allowing cognition to accelerate, decelerate, or pause in response to internal conditions.

Temporal pulses may be organized into multiple pulse bands operating at distinct characteristic frequencies. A higher-frequency band supports metabolic maintenance and low-latency responsiveness, an intermediate-frequency band supports uncertainty-driven cognition and adaptive reasoning, and a lower-frequency band supports consolidation, abstraction, memory reorganization, or offline consolidation and sleep-like reorganization processes. Pulse bands may operate hierarchically, with higher-frequency activity nested within lower-frequency activity such that a higher-frequency band executes multiple complete cycles within a single cycle of a lower-frequency band. Harmonic relationships among pulse bands may be maintained such that, for example, ωₘ≈ [symbol] and ωₛ~lωₘ, where of, ω [symbol] , and ωₛ represent characteristic frequencies of fast, medium, and slow pulse bands.

Regulation of pulse generation is performed through a closed-loop control process that monitors cognitive order parameters derived from internal state and pulse activity. Cognitive order parameters summarize properties relevant to temporal stability and coherence, including measures of phase coherence that reflect alignment of activity across regions of a cognitive manifold, spectral entropy that reflects dispersion of activity across pulse frequencies, field-energy variation that reflects magnitude of change between successive updates, activity density, or temporal curvature proxies that reflect acceleration or deceleration of cognitive evolution.

Desired operating conditions are defined as a stability corridor within a space of cognitive order parameters. Deviations from this corridor generate error signals that drive control actions. Control actions may include adjusting pulse frequency, enabling or suppressing pulse bands, modifying duty cycles, enforcing or relaxing refractory intervals, or shifting relative phase alignment among subsystems. Control behavior may incorporate proportional response, hysteresis, rate limiting, or threshold-triggered regime transitions.

Temporal synchronization across pulse bands or distributed components may be characterized using phase-coupling relationships. For example, phase evolution of oscillatory pulse generators may follow relationships such as

$${θ}_{i} = {ω}_{i} + {\sum }_{j} {K}_{ij} sin ( {θ}_{j} - {θ}_{i} ) ,$$

where θᵢ represents phase, di represents intrinsic frequency, and Kᵢⱼ represents coupling strength. An order parameter R(t) may be computed to quantify global phase coherence, with corrective feedback applied when coherence degrades.

Temporal pathologies are detected when monitored order parameters cross detection thresholds. Pulse starvation may occur when pulse activity falls below a level required to sustain cognitive continuity, indicated by sustained low field-energy variation or stagnation. Pulse storm may occur when pulses are generated at excessive frequency or density, indicated by elevated spectral entropy or overshoot of control targets. Temporal desynchronization may occur when pulse phases across regions or partitions lose alignment. Compound or cascading pathologies may also occur, wherein an initial pathology triggers a secondary failure mode, such as when aggressive suppression of a pulse storm induces subsequent starvation. Upon detection, recovery actions may include forced pulse injection, rate limiting, refractory enforcement, diffusion-based damping, phase re-locking, or localized isolation of affected graph regions, followed by monitoring to confirm restoration of stable operation.

In graph-structured manifolds, pulses may propagate as wavefronts that activate subsets of nodes and edges according to adjacency relationships. Propagation may be attenuated using damping coefficients derived from graph Laplacian properties or stability constraints, enabling localized cognitive activity without requiring global synchronization.

Update operators may be executed on hardware accelerators such as graphics processing units or other parallel computation devices. In such implementations, each temporal pulse corresponds to a bounded interval during which one or more accelerator kernels are launched. Kernel completion constitutes completion of a pulse, and successive kernel launches advance cognitive time discretely. Variability in execution latency does not disrupt cognitive coherence because advancement of cognitive time is tied to logical completion rather than physical duration.

Hardware feedback signals, including utilization metrics, thermal status, or power consumption, may be incorporated into closed-loop control. Pulse cadence or duty cycle may be adjusted to maintain hardware safety while preserving continuity of cognitive evolution.

A computer system may operate as one node in a distributed configuration comprising multiple nodes. Each node maintains local pulse regulation based on local cognitive state while exchanging synchronization signals with other nodes. Synchronization signals may include pulse phase indicators, cadence summaries, curvature proxies, or field-energy measures. Alignment may be achieved through diffusion-like propagation of synchronization signals rather than centralized control, enabling federated coherence of cognitive time without reliance on a global clock. Nodes need not execute pulses simultaneously; asynchronous alignment permits nodes to operate with differing physical latencies while maintaining logical coordination of cognitive time through signal exchange.

A refractory interval may be enforced between successive pulses, defining a minimum separation that prevents excessive pulse generation and allows cognitive fields to relax toward equilibrium between updates. Refractory enforcement may be dynamically adjusted based on stability metrics or recovery protocols.

Temporal pulse regulation may be integrated with other subsystems of a persistent cognitive machine architecture. An executive core may consume pulse signals as permissions to advance cognition and may request pulse modulation based on strategic goals or detected instability. A thought cache may interface with pulse regulation to gate retrieval, insertion, and curation of cognitive content, with different pulse bands authorizing different classes of cache operations. A sleep manager may coordinate with pulse regulation to implement sleep-like cognitive states through suppression of higher-frequency bands and activation of lower-frequency consolidation processes. A persistence layer may coordinate with pulse regulation to determine safe checkpointing intervals, scheduling state capture during specific pulse phases or following stabilization events. These integration points illustrate how temporal pulse regulation operates within a broader cognitive architecture to maintain unified temporal discipline across subsystems.

In some implementations, conservation relationships are maintained across cognitive and temporal dynamics. For example, curvature exchange between cognitive and temporal representations may satisfy relationships such as

$$d / d τ ( R\_M + βR\_T ) = 0 ,$$

ensuring bounded geometric energy and long-term stability. Such formulations illustrate non-limiting ways in which temporal regulation and cognitive stability may be enforced.

Through internally regulated temporal pulses, closed-loop feedback control, structured cognitive state evolution, and intrinsic treatment of time, the disclosed system enables persistent cognitive operation that adapts its temporal behavior to internal demand, maintains stability across extended operation, and remains decoupled from external timing artifacts.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “activity density” refers to a measure of instantaneous or aggregated cognitive activity over a portion of a cognitive manifold or during a specified pulse interval.

As used herein, “cognitive field” refers to a data structure that encodes a distribution, intensity, or influence of a particular type of cognitive content-such as factual information, uncertainty, or trajectory-across a cognitive manifold.

As used herein, “cognitive manifold” refers to a structured representational space over which cognitive state is defined and evolves, which may in some embodiments be implemented as a graph comprising nodes and edges.

As used herein, “cognitive order parameter” refers to a scalar or vector quantity derived from internal system state that summarizes temporal or structural properties of cognition, such as phase coherence, spectral entropy, or field-energy variation.

As used herein, “cognitive time” refers to a logical temporal coordinate that advances with the completion of temporal pulses and is decoupled from wall-clock or physical time.

As used herein, “conservation constraint” refers to a rule or bound that limits allowable changes to cognitive field state during updates, such as preserving total field mass, maintaining invariant relationships, or bounding curvature variation.

As used herein, “duty cycle” refers to the proportion of cognitive time during which a given pulse band is active versus suppressed.

As used herein, “federated stability corridor” refers to a set of global bounds on cognitive order parameters used to evaluate temporal coherence across distributed nodes in a federated system.

As used herein, “field-energy delta” refers to a measure of change in cognitive field values between successive pulse intervals, which may in some embodiments be computed as a norm, variance, or integral over field values.

As used herein, “graph Laplacian” refers to a matrix or operator derived from the topology of a graph-structured cognitive manifold, which may be used to control damping or diffusion of pulse wavefronts.

As used herein, “isolation directive” refers to an instruction issued to suppress or damp pulse propagation in a specified region of a cognitive manifold, often in response to a detected pathology.

As used herein, “latent field” refers to a type of cognitive field that encodes unobserved or inferred properties of cognitive state across the manifold, such as confidence, uncertainty, or trajectory.

As used herein, “pathology” refers to a temporal failure mode that disrupts stable cognitive operation, including but not limited to pulse starvation, pulse storm, and temporal desynchronization.

As used herein, “phase coherence” refers to a measure of alignment among pulse phases across different regions of a cognitive manifold or across distributed nodes.

As used herein, “pulse authorization” refers to a signal or condition that permits execution of cognitive field updates during a bounded temporal interval.

As used herein, “pulse band” refers to a class of temporal pulses operating at a characteristic frequency and serving a distinct cognitive function, such as responsiveness, reasoning, or consolidation.

As used herein, “pulse cadence” refers to the pattern or rate at which pulses occur within a pulse band, which may vary in response to internal system state.

As used herein, “pulse generator” refers to a subsystem that produces temporal pulses as internally regulated execution intervals, independent of external clocks.

As used herein, “pulse storm” refers to a pathology in which pulses occur at excessive frequency or density, resulting in unstable or chaotic cognitive evolution.

As used herein, “pulse wavefront” refers to a dynamic boundary that propagates across a cognitive manifold during a pulse interval, authorizing field updates at nodes it reaches.

As used herein, “refractory interval” refers to a minimum separation in cognitive time between successive pulses in a pulse band, used to enforce temporal stability and prevent over-excitation.

As used herein, “spectral entropy” refers to a measure of dispersion or unpredictability in pulse activity across frequency bands.

As used herein, “stability corridor” refers to a defined range of acceptable values for one or more cognitive order parameters, within which cognitive operation is considered coherent and stable.

As used herein, “temporal desynchronization” refers to a pathology in which pulse phases across subsystems or distributed nodes become misaligned, leading to incoherent or inconsistent updates.

As used herein, “temporal pulse” refers to a bounded execution interval that authorizes field updates in a cognitive system, generated internally based on system state rather than external timing sources.

As used herein, “trust weight” refers to a value representing the confidence or influence assigned to synchronization signals from a peer node, which may be computed based on historical consistency, behavioral stability, or quorum agreement.

### Conceptual Architecture of a Temporal Pulse Regulation System

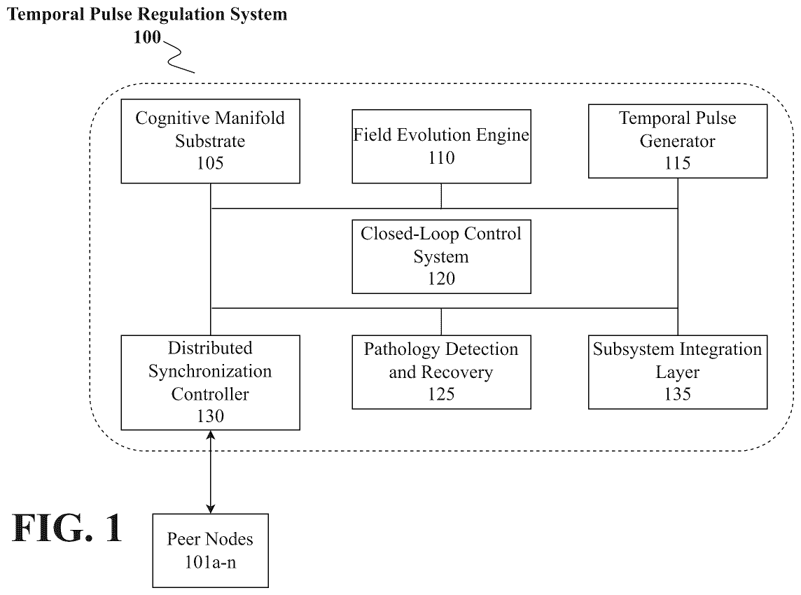

FIG. 1 is a block diagram illustrating exemplary architecture of a temporal pulse regulation system 100, in an embodiment. Through coordinated interaction among these subsystems, the temporal pulse regulation system 100 advances cognitive computation in a manner that is adaptive, self-regulating, and hardware-aware, enabling persistent, distributed cognition that remains coherent across diverse execution environments without reliance on external clocks.

A temporal pulse regulation system 100 governs cognitive activity in a persistent cognitive machine by generating internally controlled temporal pulses that authorize bounded execution intervals during which cognitive state evolves on a cognitive manifold. The system 100 comprises, in the illustrated embodiment, a cognitive manifold substrate 105, a field evolution engine 110, a temporal pulse generator 115, a closed-loop control system 120, a pathology detection and recovery system 125, a distributed synchronization controller 130, and a subsystem integration layer 135. These components operate collectively to advance cognitive computation through discrete pulse-authorized steps while maintaining stability and coherence across varying operational conditions.

A cognitive manifold substrate 105 provides a representational foundation over which cognitive state is defined and evolves. The substrate 105 represents a cognitive manifold as a graph structure comprising nodes corresponding to localized regions of latent cognitive state and edges encoding relationships such as semantic adjacency or structural affinity between those regions. One or more typed latent fields are hosted on this graph structure, with each field encoding a distribution, intensity, or influence of a particular cognitive type across positions on the manifold. The substrate 105 supplies current field state readings to a field evolution engine 110, receives field update commitments from the field evolution engine 110, provides graph topology information to a temporal pulse generator 115 for wavefront propagation, and exports partition boundary information to a distributed synchronization controller 130 for coordination across distributed deployments.

A field evolution engine 110 executes cognitive field updates as discrete computational steps corresponding to temporal pulses. During each authorized execution interval, the engine 110 reads current field values from the cognitive manifold substrate 105, applies one or more update operators that transform field state, and commits updated field values back to the substrate 105. Update operators may include graph Laplacian and diffusion operators that propagate field values across graph edges with controlled damping, cross-type coupling operators that enable interaction between different typed fields, and neighborhood aggregation operators that compute local summaries across adjacent nodes. In implementations utilizing hardware accelerators, the engine 110 maps update operators to parallel kernels whose execution is gated by temporal pulses such that kernel completion constitutes pulse completion. The engine 110 reports field-energy deltas and completion signals to a closed-loop control system 120, providing feedback that informs subsequent pulse regulation.

A temporal pulse generator 115 creates, schedules, and emits temporal pulses that authorize cognitive activity within the system 100. The generator 115 produces temporal pulses as internally generated units of cognitive time rather than clock ticks or operating system scheduling quanta, with pulse initiation, duration, and termination determined by internal cognitive state. Multiple pulse bands operating at distinct characteristic frequencies may be maintained, including a fast pulse band for metabolic maintenance and low-latency responsiveness, a medium pulse band for uncertainty-driven cognition and adaptive reasoning, and a slow pulse band for consolidation and memory reorganization. The generator 115 receives graph topology information from the cognitive manifold substrate 105 to support propagation of pulses as wavefronts across subsets of nodes and edges. Pulse authorization signals flow from the generator 115 to the field evolution engine 110, and the generator 115 reports pulse timing, phase, and cadence metrics to the closed-loop control system 120. Control commands from the closed-loop control system 120 adjust pulse frequency, phase, duty cycle, and band activation within the generator 115.

A closed-loop control system 120 monitors cognitive state and adjusts pulse generation to maintain operation within a temporal stability corridor. The control system 120 computes cognitive order parameters from field-energy deltas received from the field evolution engine 110 and from pulse metrics received from the temporal pulse generator 115, where such order parameters may include phase coherence measuring alignment of activity across regions of the cognitive manifold, spectral entropy measuring dispersion of activity across pulse frequencies, and field-energy variation measuring magnitude of change between successive pulses. Deviations between measured order parameters and stability corridor setpoints generate error signals that drive control actions directed to the temporal pulse generator 115. The control system 120 may incorporate hardware feedback signals including utilization metrics, thermal status, or power consumption from hardware accelerators, adjusting pulse cadence to maintain hardware safety while preserving cognitive continuity. Stability metrics are exported from the control system 120 to a subsystem integration layer 135, and coordination commands from a distributed synchronization controller 130 are incorporated into control action computation for federated deployments.

A pathology detection and recovery system 125 identifies temporal failure modes that degrade cognitive coherence and initiates corrective protocols. The system 125 monitors cognitive order parameters received from the closed-loop control system 120 against detection thresholds to identify conditions such as pulse starvation when pulse activity falls below a threshold required to sustain cognitive continuity, pulse storm when pulses are generated at excessive frequency or density, or temporal desynchronization when pulse phases across regions of the cognitive manifold lose alignment. Upon detecting a pathology, the system 125 emits pathology flags to the closed-loop control system 120 and issues recovery commands to the temporal pulse generator 115 that may override normal control to implement corrective protocols. For graph-structured manifolds, the system 125 may issue isolation directives to the cognitive manifold substrate 105 to contain affected regions while permitting continued operation in unaffected portions of the graph.

A distributed synchronization controller 130 coordinates temporal pulse regulation across multiple processing nodes in distributed or federated deployments. Each node in a distributed configuration maintains local pulse regulation based on local cognitive state while a distributed synchronization controller 130 exchanges synchronization signals with peer nodes 101a-n. Synchronization signals may include pulse phase indicators, pulse cadence summaries, curvature or field-energy proxies, and stability corridor deviation flags, enabling nodes to adjust local pulse behavior in response to global conditions without requiring full state transfer. The controller 130 receives partition boundary information from the cognitive manifold substrate 105 and local pulse metrics from the temporal pulse generator 115. Coordination commands flow from the controller 130 to the closed-loop control system 120, where they are incorporated into control action computation to achieve federated alignment of cognitive time without reliance on a centralized clock.

A subsystem integration layer 135 connects temporal pulse regulation with other persistent cognitive machine subsystems to maintain unified temporal discipline. The layer 135 receives stability metrics from the closed-loop control system 120 and pulse band status from the temporal pulse generator 115, using this information to gate operations in connected subsystems according to current pulse band. Coordination signals are exchanged between the layer 135 and external persistent cognitive machine subsystems, which may include an executive core, a thought cache, a sleep manager, reasoning engines, embedding pipelines, and a persistence layer. When subsystem demands change, the layer 135 may issue modulation requests to the closed-loop control system 120, which incorporates these requests into control action computation. This integration supports pulse-gated access to cognitive resources and synchronization of checkpointing with pulse boundaries.

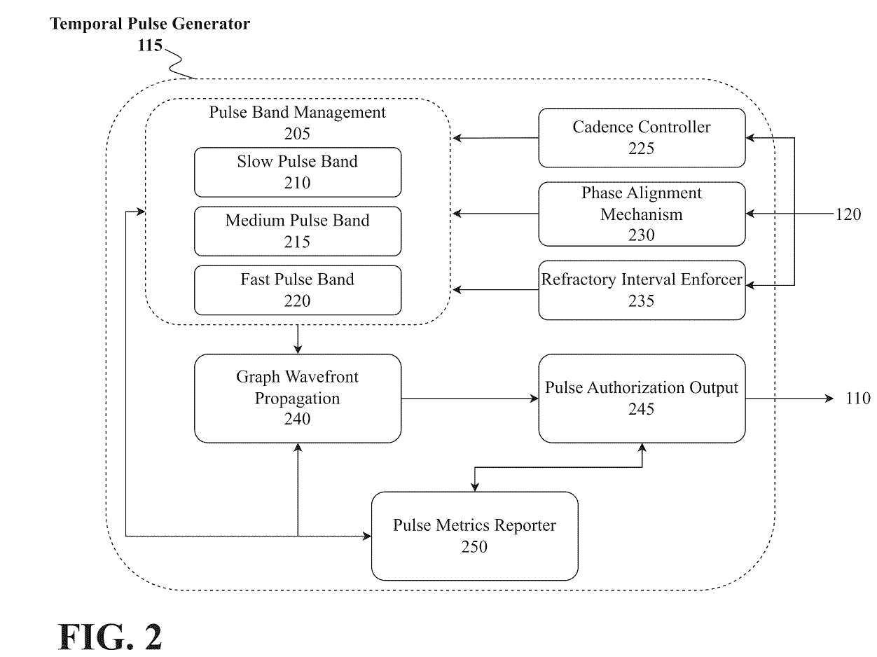

FIG. 2 is a block diagram illustrating exemplary architecture of a temporal pulse generator 115, in an embodiment. A temporal pulse generator 115 defines and emits internally generated timing signals—referred to as temporal pulses—that authorize bounded execution intervals during which cognitive field updates are permitted to occur. The generator 115 comprises a pulse band management component 205, a cadence controller 225, a phase alignment mechanism 230, a refractory interval enforcer 235, a graph wavefront propagation component 240, a pulse authorization output 245, and a pulse metrics reporter 250. These components operate collectively to produce internally generated units of cognitive time whose initiation, duration, and termination are determined by internal cognitive state rather than external timing sources.

A pulse band management component 205 maintains multiple pulse bands operating at distinct characteristic frequencies and serving different cognitive functions. The component 205 organizes pulse bands hierarchically such that higher-frequency bands are nested within lower-frequency bands. A slow pulse band 210 operates at a lower frequency and is configured to authorize consolidation, memory reorganization, abstraction, and sleep-like cognitive processes. A medium pulse band 215 operates at an intermediate frequency and is configured to authorize uncertainty-driven cognition, adaptive reasoning, and response to novel or conflicting stimuli. A fast pulse band 220 operates at a higher frequency and is configured to authorize metabolic maintenance, low-latency responsiveness, and background stabilization of cognitive state. The hierarchical nesting relationship among pulse bands 210, 215, and 220 supports orderly progression of cognitive processes wherein multiple cycles of a higher-frequency band may complete within a single cycle of a lower-frequency band.

A cadence controller 225 regulates pulse frequency within each pulse band based on control commands received from a closed-loop control system 120. The controller 225 is configured to increase pulse cadence during periods of elevated cognitive demand or instability and to decrease pulse cadence during periods of equilibrium or consolidation. Frequency adjustment signals flow from the cadence controller 225 to the pulse band management component 205, where they modulate the rate at which pulses are generated within each band.

A phase alignment mechanism 230 maintains temporal coherence across pulse bands by regulating relative phase relationships. Phase coherence between pulse bands supports orderly progression of cognitive processes and may reduce destructive interference between concurrent cognitive activities. The mechanism 230 receives control commands specifying phase corrections and applies phase adjustment signals to the pulse band management component 205. Phase misalignment across subsystems or graph partitions may result in cognitive desynchronization, and the phase alignment mechanism 230 is configured to support corrective phase re-locking when such conditions are detected.

A refractory interval enforcer 235 applies delay constraints to pulse generation, ensuring a minimum separation between successive pulses to avoid overexcitation. The enforcer 235 applies suppression signals to the pulse band management component 205 that gate pulse emission based on elapsed cognitive time since a prior pulse. Refractory intervals allow cognitive fields to relax toward equilibrium between updates and may be dynamically adjusted based on stability metrics or recovery protocols received via control commands from a closed-loop control system 120.

A graph wavefront propagation component 240 instantiates temporal pulses as wavefronts that propagate across subsets of nodes and edges within a graph-structured cognitive manifold. The component 240 receives graph topology information from a cognitive manifold substrate 105 and receives band pulse signals from the pulse band management component 205. Propagation may follow graph adjacency relationships with attenuation controlled by damping coefficients derived from graph Laplacian properties or stability constraints. The component 240 outputs wavefront signals to a pulse authorization output 245, enabling localized cognitive activity without requiring global synchronization while still permitting coherent large-scale behavior through controlled propagation.

A pulse authorization output 245 emits pulse authorization signals to a field evolution engine 110, indicating permission to execute cognitive field updates during bounded execution intervals. The output 245 receives wavefront signals from the graph wavefront propagation component 240 and formats authorization signals for consumption by the field evolution engine 110. Each emitted pulse authorization corresponds to a discrete evolution step that advances cognitive fields on the cognitive manifold.

A pulse metrics reporter 250 collects and reports pulse timing, phase, and cadence metrics to a closed-loop control system 120. The reporter 250 receives information from the pulse band management component 205, the cadence controller 225, and the phase alignment mechanism 230. Metrics reported by the component 250 provide feedback that informs subsequent control actions, supporting closed-loop regulation of temporal pulse generation based on deviations from a stability corridor defined in a space of cognitive order parameters.

In an embodiment, data flow through a temporal pulse generator 115 may proceed as follows. Control commands specifying frequency adjustments, phase corrections, duty cycle modifications, and refractory interval parameters are received from a closed-loop control system 120 and are distributed to a cadence controller 225, a phase alignment mechanism 230, and a refractory interval enforcer 235. The cadence controller 225 transmits frequency adjustment signals to a pulse band management component 205, modulating the rate at which pulses are generated within each of a slow pulse band 210, a medium pulse band 215, and a fast pulse band 220. The phase alignment mechanism 230 transmits phase adjustment signals to the pulse band management component 205, regulating relative phase relationships among the pulse bands. The refractory interval enforcer 235 transmits suppression signals to the pulse band management component 205, gating pulse emission to enforce minimum separation between successive pulses. Graph topology information is received from a cognitive manifold substrate 105 and provided to a graph wavefront propagation component 240, which uses the topology to determine propagation paths and damping characteristics for pulse wavefronts. Band pulse signals flow from the pulse band management component 205 to the graph wavefront propagation component 240, which instantiates corresponding wavefronts that propagate across subsets of nodes and edges according to the received topology. Wavefront signals flow from the graph wavefront propagation component 240 to a pulse authorization output 245, which emits pulse authorization signals to a field evolution engine 110 indicating permission to execute cognitive field updates. Concurrently, a pulse metrics reporter 250 collects timing, phase, and cadence information from the pulse band management component 205, the cadence controller 225, and the phase alignment mechanism 230, and transmits pulse metrics to the closed-loop control system 120 to support subsequent control action computation.

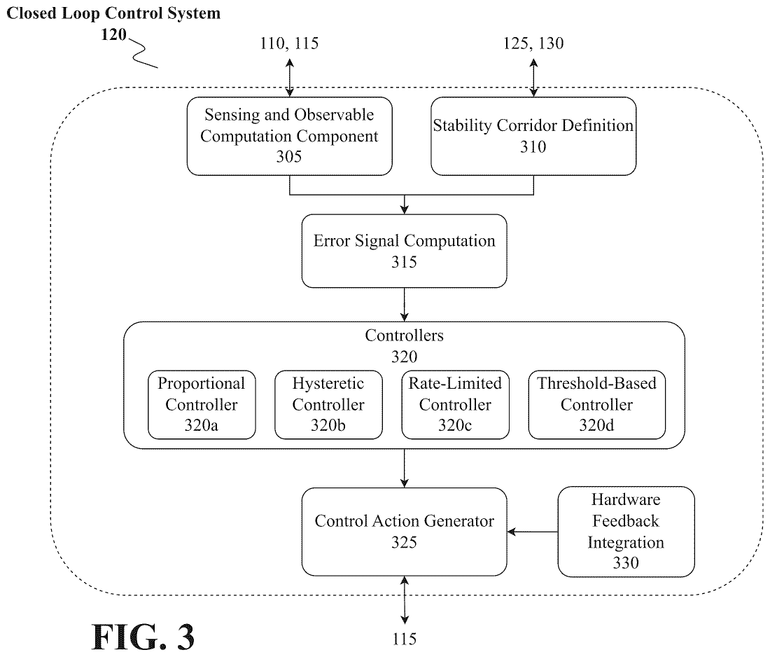

FIG. 3 is a block diagram illustrating exemplary architecture of a closed-loop control system 120, in an embodiment. A closed-loop control system 120 monitors cognitive state and adjusts pulse generation to maintain operation within a temporal stability corridor. The system 120 comprises a sensing and observable computation component 305, a stability corridor definition component 310, an error signal computation component 315, a controllers component 320, a control action generator 325, and a hardware feedback integration component 330. These components operate collectively to transform feedback derived from internal cognitive state into control actions that regulate temporal pulse characteristics.

A sensing and observable computation component 305 computes cognitive order parameters from field state and pulse activity data received from other components of a temporal pulse regulation system 100. The component 305 receives field-energy deltas from a field evolution engine 110 and pulse metrics from a temporal pulse generator 115. Cognitive order parameters computed by the component 305 may include phase coherence measuring alignment of activity across regions of a cognitive manifold, spectral entropy measuring dispersion of activity across pulse frequencies, field-energy variation measuring magnitude of change in cognitive fields between successive pulses, activity density measuring instantaneous and aggregated cognitive activity levels, and temporal curvature proxies measuring acceleration or deceleration of cognitive evolution. These order parameters are transmitted to an error signal computation component 315 for comparison against stability corridor setpoints.

A stability corridor definition component 310 maintains setpoints that define desired operating conditions in a space of cognitive order parameters. The setpoints collectively define a temporal stability corridor within which cognitive operation is considered stable and coherent.

Setpoints may be static, adaptive, or context-dependent, and may be adjusted based on system history, workload characteristics, or hardware capabilities. The component 310 transmits setpoint values to an error signal computation component 315, where they serve as reference values against which measured observables are compared.

An error signal computation component 315 computes deviation metrics by comparing measured cognitive order parameters against corresponding setpoints from a stability corridor definition component 310. The component 315 receives observable values from a sensing and observable computation component 305 and reference values from a stability corridor definition component 310. Error signals generated by the component 315 may indicate conditions such as excessive activity approaching pulse storm, insufficient activity indicating starvation, phase dispersion indicating desynchronization, or rapid curvature changes indicating instability. The component 315 may also receive pathology flags from a pathology detection and recovery system 125 and coordination commands from a distributed synchronization controller 130, incorporating these inputs into deviation computation. Error signals are transmitted to a controllers component 320 for processing.

A controllers component 320 transforms error signals into controller outputs that inform control action generation. The component 320 comprises multiple controller types that may operate concurrently or hierarchically. A proportional controller 320a adjusts pulse parameters in proportion to error magnitude, providing continuous correction scaled to the degree of deviation from setpoints. A hysteretic controller 320b introduces deadbands to prevent oscillatory behavior that might otherwise arise from rapid switching between control states. A rate-limited controller 320c constrains the rate of change of pulse parameters, preventing abrupt transitions that could destabilize cognitive field evolution. A threshold-based controller 320d triggers discrete transitions between pulse regimes when error signals cross predefined threshold values. Controller outputs from these components are transmitted to a control action generator 325.

A control action generator 325 synthesizes controller outputs, subsystem modulation requests, and hardware constraints into control commands directed to a temporal pulse generator 115. Control actions generated by the component 325 may include increasing or decreasing pulse frequency within a pulse band, enabling or suppressing entire pulse bands, modifying pulse duration or duty cycle, enforcing or relaxing refractory intervals, and shifting relative phase alignment between subsystems. The generator 325 receives throttling signals from a hardware feedback integration component 330, which may constrain control actions to maintain hardware safety. The generator 325 also receives modulation requests from a subsystem integration layer 135, incorporating subsystem demands into control action computation. Control commands are transmitted from the generator 325 to a temporal pulse generator 115.

A hardware feedback integration component 330 monitors hardware telemetry from one or more hardware accelerators and derives constraints that influence control action generation. Hardware status signals may include utilization metrics, thermal status, and power consumption data. The component 330 processes these signals to generate throttling or limiting signals that are transmitted to a control action generator 325. When hardware feedback indicates elevated thermal load or resource contention, the component 330 may signal the control action generator 325 to reduce pulse cadence or adjust duty cycles to maintain hardware safety while preserving continuity of cognitive evolution.

In an embodiment, data flow through a closed-loop control system 120 may proceed as follows. Field-energy deltas are received from a field evolution engine 110 and pulse metrics are received from a temporal pulse generator 115, with both inputs provided to a sensing and observable computation component 305. The component 305 computes cognitive order parameters including phase coherence, spectral entropy, field-energy variation, activity density, and temporal curvature proxies from these inputs. Observable values flow from the sensing and observable computation component 305 to an error signal computation component 315, while setpoint values flow from a stability corridor definition component 310 to the same component 315. The error signal computation component 315 computes deviations between observables and setpoints, incorporating pathology flags received from a pathology detection and recovery system 125 and coordination commands received from a distributed synchronization controller 130. Error signals flow from the component 315 to a controllers component 320, where a proportional controller 320a, a hysteretic controller 320b, a rate-limited controller 320c, and a threshold-based controller 320d process the error signals to generate controller outputs. Controller outputs flow to a control action generator 325, which also receives throttling signals from a hardware feedback integration component 330 based on hardware status received from hardware accelerators, and modulation requests from a subsystem integration layer 135. The control action generator 325 produces control commands specifying frequency adjustments, phase corrections, duty cycle modifications, and refractory interval parameters, which are transmitted to a temporal pulse generator 115.

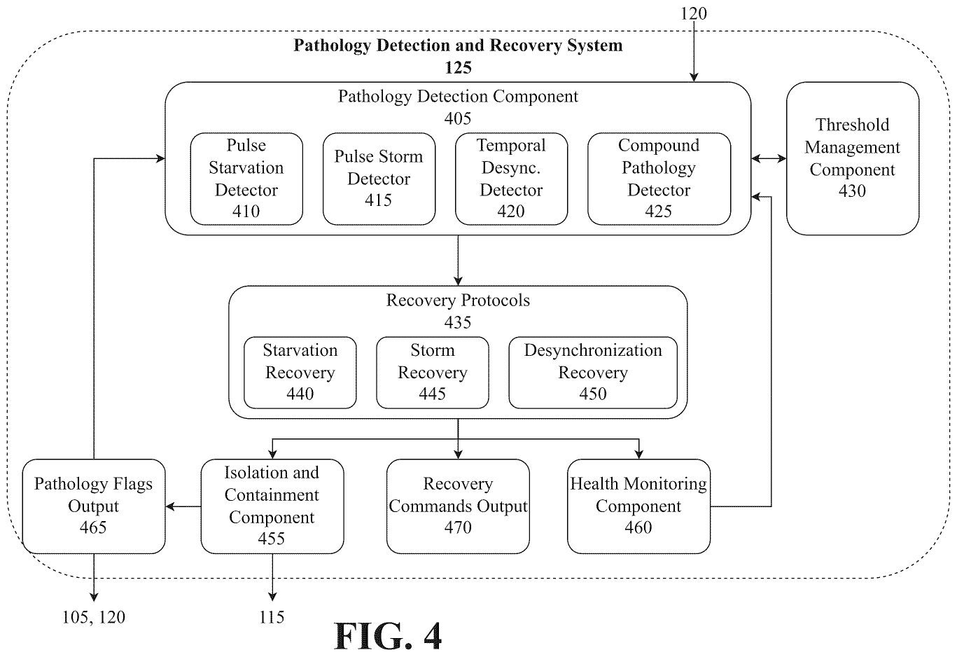

FIG. 4 is a block diagram illustrating exemplary architecture of a pathology detection and recovery system 125, in an embodiment. A pathology detection and recovery system 125 identifies temporal failure modes that degrade cognitive coherence and initiates corrective protocols to restore stable operation. The system 125 comprises a pathology detection component 405, a threshold management component 430, a recovery protocols component 435, an isolation and containment component 455, a health monitoring component 460, a pathology flags output 465, and a recovery commands output 470. These components operate collectively to detect deviations from temporally stable behavior, initiate targeted recovery actions, and confirm return to coherent cognitive operation.

A pathology detection component 405 evaluates cognitive order parameters against detection thresholds to identify temporal pathologies. The component 405 comprises three specialized detectors. A pulse starvation detector 410 detects conditions in which pulse activity falls below continuity-sustaining thresholds, with indicators such as sustained low field-energy variation, reduced activity density, and prolonged stagnation of cognitive dynamics. A pulse storm detector 415 identifies overactive pulse conditions based on rapid increases in spectral entropy, large field-energy deltas between pulses, or persistent overshoot of control setpoints. A temporal desynchronization detector 420 identifies divergence in pulse phases across subsystems or graph partitions, indicated by phase coherence loss, inconsistent updates, or oscillatory feedback. A compound pathology detector 425 integrates outputs from the other detectors and identifies interdependent or cascading failure modes-such as when suppression of a storm induces subsequent starvation-enabling coordinated response.

A threshold management component 430 maintains detection thresholds for each monitored order parameter. Thresholds may be static, dynamically adjusted, or context-dependent. Adaptive thresholds may be modified based on historical system performance, workload characteristics, or hardware telemetry, improving sensitivity while reducing false positives. Threshold values are transmitted to the pathology detection component 405 to support real-time evaluation.

A recovery protocols component 435 initiates corrective actions corresponding to detected pathologies. The component 435 comprises recovery subsystems matched to pathology types. A starvation recovery component 440 addresses underactivity through forced pulse injection, temporary relaxation of refractory intervals, and elevation of fast- or medium-band priority. A storm recovery component 445 applies rate limiting, enforces refractory intervals, initiates diffusion-based damping, and may suppress high-frequency pulse bands. A desynchronization recovery component 450 triggers phase re-locking, initiates synchronization pulse exchanges, and aligns subsystems hierarchically by imposing slower-band coherence constraints. When compound pathologies are detected, the component 435 coordinates recovery actions across multiple subsystems.

An isolation and containment component 455 enables localized suppression of pulse activity in graph-structured cognitive manifolds. When a pathological condition is spatially localized, the component 455 may issue isolation directives that suppress or damp pulses in affected regions while allowing continued operation elsewhere. This supports graceful degradation and resilience in distributed or partitioned systems. The component 455 receives targeting signals from the recovery protocols component 435.

A health monitoring component 460 tracks post-recovery system dynamics to verify that cognitive activity returns to within the stability corridor. The component 460 evaluates current order parameters against acceptable bounds and may retain historical pathology data to inform future threshold adjustments and improve resilience. Health status is fed back to the pathology detection component 405 to support ongoing evaluation during and after recovery periods.

A pathology flags output 465 transmits detection results to a closed-loop control system 120. The output 465 receives detection signals from the compound pathology detector 425 and formats pathology indicators for downstream control logic. These flags inform the control system 120 of failure conditions and support integration of recovery state into subsequent control computations.

A recovery commands output 470 transmits protocol signals to a temporal pulse generator 115 and isolation directives to a cognitive manifold substrate 105. Recovery commands may override normal control behavior to implement actions such as forced injection, damping, or synchronization. Isolation directives specify which graph partitions should undergo localized pulse suppression.

In an embodiment, data flow through a pathology detection and recovery system 125 proceeds as follows. Cognitive order parameters are received from a closed-loop control system 120 and routed to a pathology detection component 405. A threshold management component 430 provides thresholds against which order parameters are evaluated by a pulse starvation detector 410, a pulse storm detector 415, and a temporal desynchronization detector 420. Detection signals from these detectors flow to a compound pathology detector 425, which identifies interacting or cascading failures. Detection results are transmitted via a pathology flags output 465 to a closed-loop control system 120 and simultaneously provided to a recovery protocols component 435. Within component 435, a starvation recovery component 440, storm recovery component 445, and desynchronization recovery component 450 initiate corresponding recovery signals. When required, these signals are passed to an isolation and containment component 455 to target specific graph regions, and to a recovery commands output 470 for transmission to external components. Recovery commands are sent to a temporal pulse generator 115, while isolation directives are delivered to a cognitive manifold substrate 105. Concurrently, recovery status signals from the recovery protocols component 435 are evaluated by a health monitoring component 460, which confirms successful recovery and provides feedback to the detection component 405 to support sustained monitoring.

Together, these components ensure that the temporal pulse regulation system remains stable, resilient, and self-correcting in the presence of anomalous dynamics, enabling long-running cognitive systems to recover from instability without external intervention or full-system interruption.

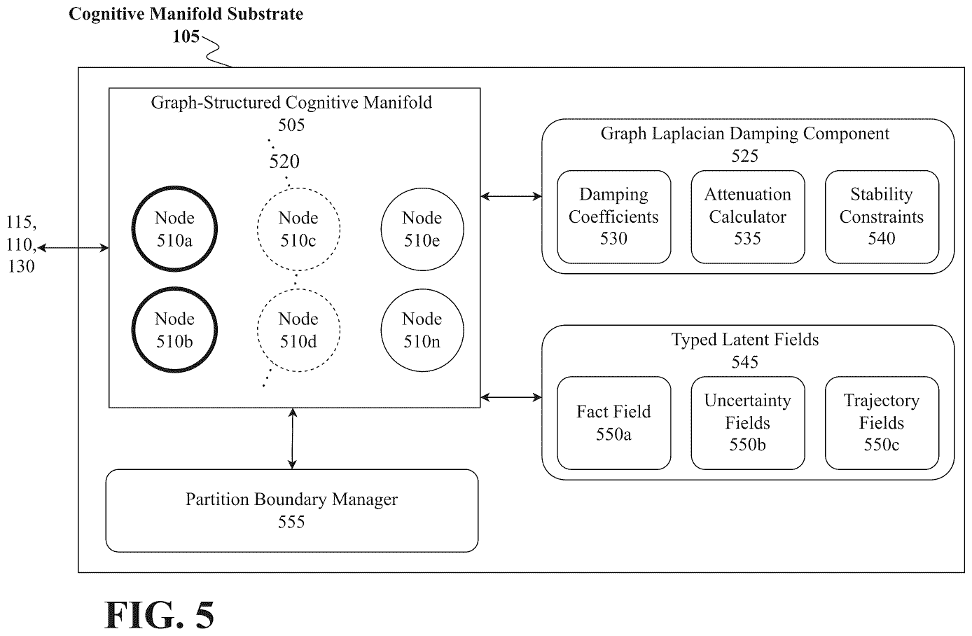

FIG. 5 is a block diagram illustrating exemplary architecture of a cognitive manifold substrate 105, in an embodiment. A cognitive manifold substrate 105 provides a representational foundation over which cognitive state is defined and evolves, maintaining structural organization of cognitive content and defining topology across which temporal pulses propagate. The substrate 105 comprises, in the illustrated embodiment, a graph-structured cognitive manifold 505, a graph Laplacian damping component 525, typed latent fields 545, and a partition boundary manager 555. These components operate collectively to support sparse, scalable, and locality-preserving execution of cognitive updates while enabling pulse wavefronts to traverse the manifold structure with controlled attenuation.

A graph-structured cognitive manifold 505 represents cognitive state as a graph comprising nodes 510a-n and edges 515. Nodes 510a-n correspond to localized regions of latent cognitive state, with each node maintaining field values that encode cognitive content at that position on the manifold. Edges 515 encode relationships between nodes such as semantic adjacency, transition likelihood, or structural affinity, defining pathways along which field values may propagate and pulse wavefronts may travel. The graph representation enables cognitive updates to be executed in a locality-preserving manner, where operations at a given node may depend primarily on values at adjacent nodes rather than requiring global state access. In the illustrated embodiment, nodes depicted with thick borders represent nodes that have been reached by a pulse wavefront and are authorized for field updates, nodes depicted with dashed borders represent nodes at the wavefront boundary that are in the process of being reached, and nodes depicted with thin borders represent nodes not yet reached by the current pulse wavefront.

A pulse wavefront 520 represents a temporal pulse instantiated as a traversing activation pattern that moves across existing nodes and edges within a graph-structured cognitive manifold 505. When a temporal pulse generator 115 initiates a pulse, a corresponding wavefront 520 begins at one or more designated nodes and advances through the graph along adjacency relationships defined by edges 515, progressively reaching additional nodes as it travels. Nodes reached by a wavefront 520 become authorized to undergo cognitive field updates during the associated pulse interval, while nodes not yet reached by the wavefront remain inactive for that pulse. The wavefront traversal model enables localized cognitive activity without requiring global synchronization while still permitting coherent large-scale behavior through controlled movement across the graph structure.

A graph Laplacian damping component 525 regulates pulse traversal by applying attenuation as wavefronts move across a graph-structured cognitive manifold 505. The component 525 comprises damping coefficients 530 that specify attenuation rates for pulse energy as it travels across edges, an attenuation calculator 535 that computes effective pulse strength at each node based on graph distance and damping parameters, and stability constraints 540 that may limit traversal extent to prevent runaway excitation. Damping coefficients 530 may be derived from graph Laplacian properties or may be dynamically adjusted based on stability metrics received from a closed-loop control system 120. The attenuation calculator 535 receives graph topology information from a graph-structured cognitive manifold 505 and applies damping coefficients 530 to determine how pulse strength decreases with traversal distance, thereby controlling the spatial extent and intensity of each pulse wavefront.

Typed latent fields 545 are hosted on a graph-structured cognitive manifold 505, with field values associated with nodes 510a-n. Each typed latent field encodes a distribution, intensity, or influence of a particular cognitive type across positions on the manifold. Exemplary field types include a fact field 550a encoding factual anchors or stable knowledge, an uncertainty field 550b encoding confidence or ambiguity measures, and a trajectory field 550c encoding reasoning paths or cognitive evolution directions. Field values at each node evolve according to update operators applied during authorized pulse intervals, with a field evolution engine 110 reading current values, applying operators, and committing updated values back to the typed latent fields 545.

A partition boundary manager 555 supports distributed execution by maintaining information about how a graph-structured cognitive manifold 505 may be partitioned into subgraphs. For distributed deployments where different portions of the manifold reside on different processing nodes, the partition boundary manager 555 tracks inter-partition edge connectivity so that pulse wavefronts and field updates can be coordinated across partition boundaries. Boundary information is exported to a distributed synchronization controller 130, which uses this information to coordinate pulse timing and field state synchronization across nodes in a distributed configuration.

In an embodiment, data flow through a cognitive manifold substrate 105 proceeds as follows. Pulse signals are received from a temporal pulse generator 115 and initiate a pulse wavefront 520 that traverses existing nodes within a graph-structured cognitive manifold 505, advancing along edges 515 according to adjacency relationships. A graph Laplacian damping component 525 receives topology information from a graph-structured cognitive manifold 505 and applies damping to wavefront traversal based on damping coefficients 530 and stability constraints 540. As a pulse wavefront 520 reaches successive nodes 510a-n, those nodes become authorized for field updates, and a field evolution engine 110 reads current field values from typed latent fields 545, applies update operators, and commits updated values back to the fields. A partition boundary manager 555 exports boundary information to a distributed synchronization controller 130 to support coordination of pulse traversal and field updates across distributed partitions. Current field state readings flow from typed latent fields 545 to a field evolution engine 110, while field update commitments flow back from a field evolution engine 110 to typed latent fields 545 upon completion of pulse-authorized updates.

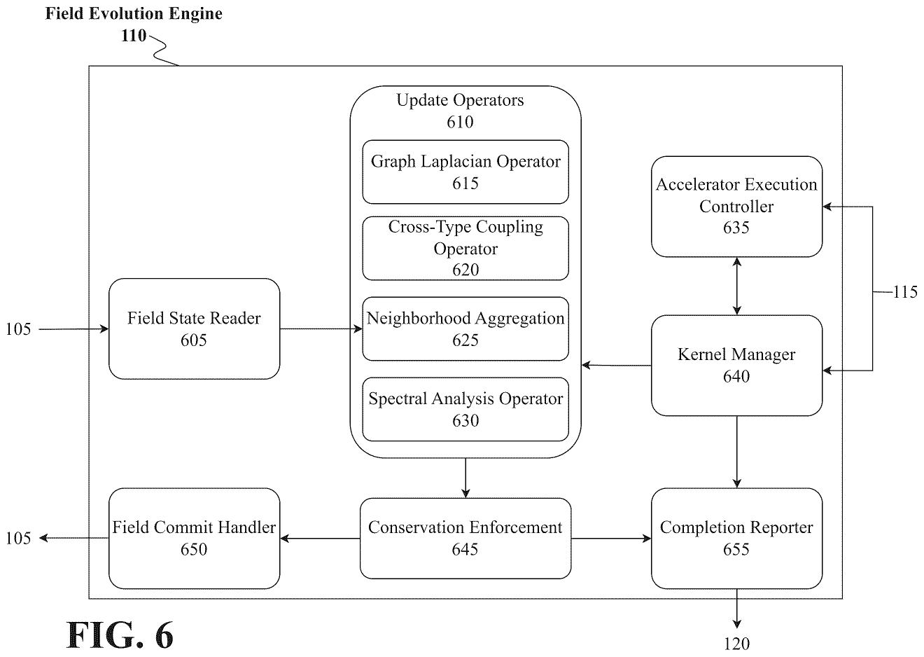

FIG. 6 is a block diagram illustrating exemplary architecture of a field evolution engine 110, in an embodiment. A field evolution engine 110 executes cognitive field updates as discrete computational steps corresponding to temporal pulses, transforming field state according to one or more evolution operators and committing updated values to a cognitive manifold substrate 105. The engine 110 comprises, in the illustrated embodiment, a field state reader 605, an update operators component 610, an accelerator execution controller 635, a kernel manager 640, a conservation enforcement component 645, a field commit handler 650, and a completion reporter 655. These components operate collectively to approximate continuous field evolution through discrete update steps, with each update step corresponding to a temporal pulse and, in some embodiments, constituting a bounded increment of cognitive time.

A field state reader 605 retrieves current field values from a cognitive manifold substrate 105 at initiation of an authorized pulse interval. In an embodiment, the reader 605 accesses typed latent fields hosted on a graph-structured cognitive manifold and extracts field values associated with nodes that are authorized for update during the current pulse, where an authorized node set may be determined based on pulse wavefront propagation, band gating, or other authorization signals received directly or indirectly from a temporal pulse generator 115 or from authorization annotations maintained by the cognitive manifold substrate 105. Current field values flow from the reader 605 to an update operators component 610, where they serve as input for transformation by one or more evolution operators.

An update operators component 610 applies one or more field evolution operators to current field values to compute candidate updated field state. The component 610 comprises multiple operator types that may be selectively invoked in a non-limiting manner based on operator-selection policies, cognitive demand signals, or control inputs. A graph Laplacian operator 615 propagates field values across graph edges with controlled damping, supporting diffusion-like spreading of cognitive state across adjacent regions of a manifold. In an embodiment, damping coefficients may be statically defined, derived from graph Laplacian properties, or dynamically adjusted based on stability metrics. A cross-type coupling operator 620 enables interaction between different typed fields, allowing values in one field type to influence evolution of another field type. A neighborhood aggregation operator 625 computes local summaries across adjacent nodes, supporting consolidation of distributed cognitive content. A spectral analysis operator 630 computes frequency-domain or spectral characteristics of field activity, such as power distributions or entropy proxies, and produces spectral features that may be provided as feedback to a closed-loop control system 120 or a sensing component thereof. Updated field values computed by the update operators component 610 flow to a conservation enforcement component 645 for validation prior to commitment.

In some embodiments, execution of update operators is performed on one or more hardware accelerators. An accelerator execution controller 635 receives pulse authorization signals from a temporal pulse generator 115 and, upon receipt of such authorization, coordinates execution of update operators within pulse-authorized execution boundaries. The accelerator execution controller 635 may instruct a kernel manager 640 to dispatch kernels corresponding to selected operator types. A kernel manager 640 maps operator types to kernel implementations and schedules kernel dispatch on one or more hardware accelerators such as graphics processing units, tensor processing units, or other parallel computing devices. In other embodiments, update operators may be executed using non-accelerated processing resources without departing from the scope of the disclosure. Kernel completion signals flow from the kernel manager 640 to a completion reporter 655, indicating conclusion of pulse-authorized computation.

A conservation enforcement component 645 validates candidate updated field values against one or more conservation constraints before permitting commitment to a cognitive manifold substrate 105. Conservation constraints may include preservation of invariants, maintenance of anchor relationships, or bounds on total field mass, energy, or curvature. Updates that would violate conservation requirements may be suppressed, projected into a permitted state space, modified, or flagged for corrective handling. In some embodiments, conservation constraints may additionally be incorporated into operator execution logic to reduce generation of invalid updates. Validated field values flow from the conservation enforcement component 645 to a field commit handler 650.

A field commit handler 650 commits validated field updates to a cognitive manifold substrate 105, completing the discrete evolution step associated with a temporal pulse. The handler 650 transmits field update commitments to typed latent fields hosted on a graph-structured cognitive manifold, where committed values become the current field state for subsequent pulse intervals. In an embodiment, commitment occurs only upon completion of pulse-authorized execution, thereby aligning state advancement with pulse boundaries. Completion of the commit operation may advance a cognitive time coordinate by one discrete increment corresponding to the concluded pulse.

A completion reporter 655 generates feedback metrics associated with completed field updates and transmits feedback signals to a closed-loop control system 120. The reporter 655 receives kernel completion signals from a kernel manager 640 and update status indicators from a conservation enforcement component 645. In an embodiment, the reporter 655 computes one or more field-energy deltas representing magnitude of change between pre-update and post-update field values, where such deltas may be computed using one or more norms, aggregation functions, or per-field measures over nodes affected by the pulse. Completion indicators and feedback metrics are transmitted to the closed-loop control system 120, where they inform subsequent pulse regulation decisions, including cadence adjustment, refractory enforcement, or band modulation.

In an embodiment, data flow through a field evolution engine 110 may proceed as follows. Pulse authorization signals are received from a temporal pulse generator 115 and provided to an accelerator execution controller 635, which, in response, coordinates with a kernel manager 640 to dispatch kernels implementing selected update operators within pulse-authorized execution intervals. Concurrently, a field state reader 605 retrieves current field values from a cognitive manifold substrate 105 for nodes authorized for update and provides these values to an update operators component 610. The kernel manager 640 dispatches kernels implementing, by way of example and not limitation, a graph Laplacian operator 615, a cross-type coupling operator 620, a neighborhood aggregation operator 625, and a spectral analysis operator 630 for execution on hardware accelerators or other processing resources. Candidate updated field values flow from the update operators component 610 to a conservation enforcement component 645, which validates updates against conservation constraints. Validated values flow from the conservation enforcement component 645 to a field commit handler 650, which commits updates to a cognitive manifold substrate 105. Kernel completion signals and update status indicators flow to a completion reporter 655, which computes feedback metrics including field-energy deltas and transmits completion signals and feedback metrics to a closed-loop control system 120 to support adaptive regulation of subsequent temporal pulses.

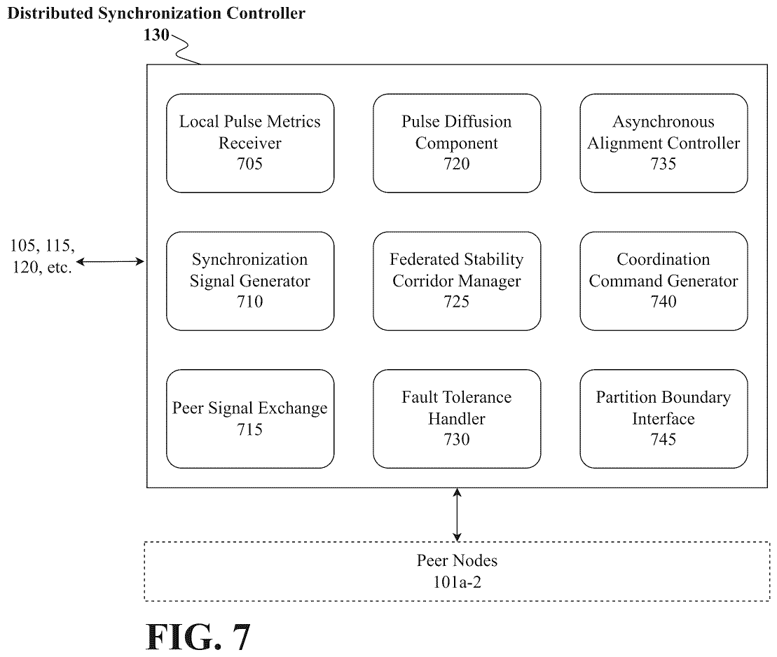

FIG. 7 is a block diagram illustrating exemplary architecture of a distributed synchronization controller 130, in an embodiment. A distributed synchronization controller 130 coordinates temporal pulse regulation across multiple processing nodes in distributed or federated deployments, maintaining coherence of a cognitive time construct without reliance on a centralized clock. The controller 130 comprises, in the illustrated embodiment, a local pulse metrics receiver 705, a synchronization signal generator 710, a peer signal exchange 715, a pulse diffusion component 720, a federated stability corridor manager 725, a fault tolerance handler 730, an asynchronous alignment controller 735, a coordination command generator 740, and a partition boundary interface 745. These components operate collectively, in a non-limiting arrangement, to enable nodes in a distributed configuration to maintain local pulse autonomy while achieving federated temporal alignment through exchange and integration of compact synchronization signals.

A local pulse metrics receiver 705 receives pulse timing, phase, and cadence information from a temporal pulse generator 115 operating on a local node. The receiver 705 collects metrics characterizing local pulse activity, which may include current pulse frequency within one or more pulse bands, relative phase relationships among pulse bands, recent pulse completion events, or other temporal observables. These local metrics are transmitted to a synchronization signal generator 710, where they inform generation of outbound synchronization signals for transmission to peer nodes.

A synchronization signal generator 710 produces reduced-order synchronization signals that summarize local temporal state for exchange with peer nodes. Synchronization signals generated by the component 710 may include, by way of example and not limitation, pulse phase indicators encoding relative phase positions within pulse bands, pulse cadence summaries characterizing local pulse frequency, or field-energy proxies derived from field-energy deltas or other cognitive activity measures computed elsewhere in the system. Such signals are configured to support federated alignment of temporal behavior without requiring full cognitive state transfer between nodes. Outbound synchronization signals flow from the generator 710 to a peer signal exchange 715 for transmission to peer nodes.

A peer signal exchange 715 manages bidirectional communication of synchronization signals with peer distributed synchronization controllers operating on other nodes in a distributed configuration. The exchange 715 transmits outbound synchronization signals to peer nodes 101a-n and receives inbound synchronization signals from those peers. Received signals may be distributed, in a non-limiting manner, to a pulse diffusion component 720 for gradual integration, to a federated stability corridor manager 725 for distributed stability assessment, and to a fault tolerance handler 730 for trust or consistency evaluation.

A pulse diffusion component 720 integrates synchronization information using diffusion-like or smoothing mechanisms that avoid abrupt synchronization corrections. Rather than enforcing immediate alignment, the component 720 gradually incorporates received signals to support smooth convergence of temporal behavior across nodes. In various embodiments, diffusion may be implemented using weighted averaging, exponential smoothing, gossip-style propagation, or other incremental integration techniques. The component 720 may receive topology information from a partition boundary interface 745 to inform diffusion pathways when a cognitive manifold is partitioned across multiple nodes. Diffused synchronization signals flow from the component 720 to an asynchronous alignment controller 735.

A federated stability corridor manager 725 maintains global or federated temporal stability corridor bounds that complement local stability corridors maintained by individual nodes. The manager 725 receives synchronization signals from a peer signal exchange 715 and evaluates whether distributed temporal behavior satisfies one or more global coherence conditions, such as bounded phase dispersion, cadence alignment within tolerance, or aggregate field-energy variation remaining within acceptable limits. When deviations are detected, the manager 725 generates one or more indicators reflecting global instability or emerging misalignment. Federated corridor bounds and deviation indicators flow from the manager 725 to an asynchronous alignment controller 735.

A fault tolerance handler 730 evaluates synchronization signals received from peer nodes and assigns trust weights or influence modifiers based on factors such as historical consistency, behavioral stability, or quorum agreement. The handler 730 may identify outlier pulse behavior indicative of faulty, misconfigured, or adversarial nodes and may reduce or suppress the influence of such nodes on local synchronization decisions. Trust-weighted assessments generated by the handler 730 flow to an asynchronous alignment controller 735, supporting robust synchronization in the presence of unreliable peers.

An asynchronous alignment controller 735 synthesizes diffused synchronization signals, federated stability corridor information, and trust-weighted assessments to determine appropriate adjustments to local temporal pulse behavior. The controller 735 enables coordination without requiring simultaneous pulse execution across nodes, allowing nodes to operate with differing physical latencies, execution speeds, or hardware characteristics while maintaining logical coherence of cognitive time. Alignment state information or adjustment directives flow from the controller 735 to a coordination command generator 740.

A coordination command generator 740 produces coordination commands for transmission to a closed-loop control system 120 operating on the local node. Coordination commands may specify non-limiting adjustments to pulse frequency, phase alignment, duty cycle, or other temporal control parameters, and are formatted for incorporation into local control action computation rather than direct override of pulse generation. The generator 740 translates alignment decisions from an asynchronous alignment controller 735 into commands compatible with the control interface of a closed-loop control system 120.

A partition boundary interface 745 receives partition boundary information from a cognitive manifold substrate 105, indicating how a graph-structured cognitive manifold is partitioned across nodes in a distributed configuration. This topology information may be provided to a pulse diffusion component 720 to inform diffusion pathways and, in some embodiments, to support coordination of pulse wavefront propagation across partition boundaries.

In an embodiment, data flow through a distributed synchronization controller 130 may proceed as follows. Local pulse metrics are received from a temporal pulse generator 115 and provided to a local pulse metrics receiver 705, which transmits the metrics to a synchronization signal generator 710. The generator 710 produces outbound synchronization signals that flow to a peer signal exchange 715 for transmission to peer nodes 101a-n. Inbound synchronization signals received from peer nodes flow from a peer signal exchange 715 to a pulse diffusion component 720, a federated stability corridor manager 725, and a fault tolerance handler 730. Partition boundary information is received from a cognitive manifold substrate 105 at a partition boundary interface 745 and provided to a pulse diffusion component 720 to inform diffusion topology. Diffused synchronization signals flow from a pulse diffusion component 720 to an asynchronous alignment controller 735, which also receives federated corridor indicators from a federated stability corridor manager 725 and trust-weighted assessments from a fault tolerance handler 730. Alignment state information flows from an asynchronous alignment controller 735 to a coordination command generator 740, which transmits coordination commands to a closed-loop control system 120 for incorporation into local temporal control action computation.

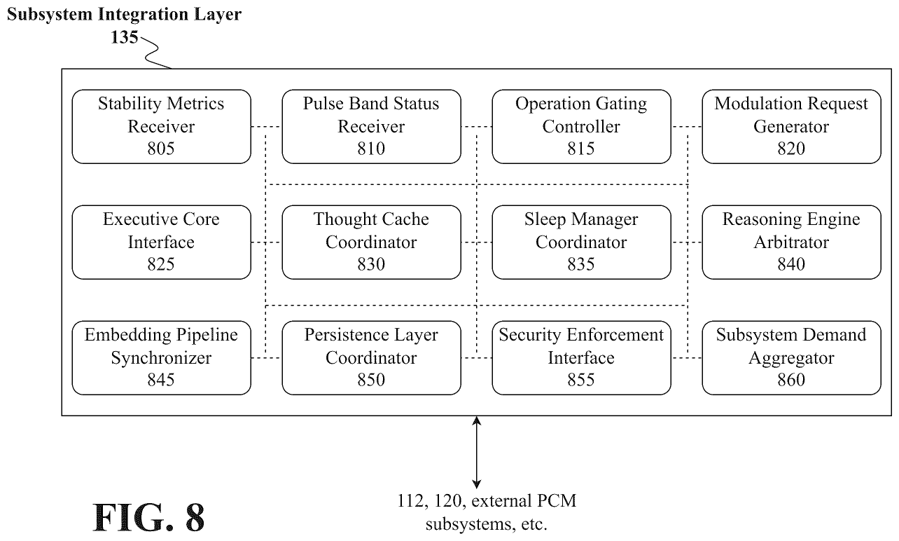

FIG. 8 is a block diagram illustrating exemplary architecture of a subsystem integration layer 135, in an embodiment. A subsystem integration layer 135 connects temporal pulse regulation with external persistent cognitive machine subsystems, maintaining unified temporal discipline across a cognitive system by coordinating execution permissions and feedback across subsystems based on pulse timing rather than external clocks. The layer 135 comprises, in the illustrated embodiment, a stability metrics receiver 805, a pulse band status receiver 810, an operation gating controller 815, a modulation request generator 820, an executive core interface 825, a thought cache coordinator 830, a sleep manager coordinator 835, a reasoning engine arbitrator 840, an embedding pipeline synchronizer 845, a persistence layer coordinator 850, a security enforcement interface 855, and a subsystem demand aggregator 860. These components operate collectively, in a non-limiting arrangement, to gate operations in connected subsystems according to current pulse band status and stability conditions and to communicate subsystem-level temporal demands back to pulse regulation mechanisms.

A stability metrics receiver 805 receives stability metrics from a closed-loop control system 120, providing information about current temporal stability conditions to the integration layer 135. Stability metrics may include, by way of example and not limitation, measures of phase coherence, field-energy variation, activity density, or proximity to stability corridor boundaries. These metrics are transmitted to an operation gating controller 815, where they inform decisions about whether certain subsystem operations should be permitted, deferred, or conditioned based on current stability conditions.

A pulse band status receiver 810 receives pulse band status information from a temporal pulse generator 115, indicating which pulse bands are currently active and, in some embodiments, relative phase or duty-cycle information within each band. Pulse band status enables the integration layer 135 to determine which classes of subsystem operations are authorized during a current pulse interval. Pulse band status information flows from the receiver 810 to an operation gating controller 815.

An operation gating controller 815 evaluates authorization conditions for subsystem operations based on pulse band status, received stability metrics, and, in some embodiments, predefined policies or priority rules. The controller 815 generates gating signals that authorize, defer, or limit execution of subsystem operations according to pulse band associations and temporal stability conditions. In a non-limiting example, fast pulse bands may authorize lightweight or low-latency operations, medium pulse bands may authorize adaptive or reasoning-related operations, and slow pulse bands may authorize consolidation, reorganization, or structural updates. Gating signals flow from the controller 815 to one or more subsystem interface components, including an executive core interface 825, a thought cache coordinator 830, a sleep manager coordinator 835, a reasoning engine arbitrator 840, an embedding pipeline synchronizer 845, a persistence layer coordinator 850, and a security enforcement interface 855.

An executive core interface 825 coordinates with an executive core of a persistent cognitive machine, transmitting pulse-gated permissions that indicate when high-level cognitive advancement may occur. The interface 825 receives gating signals from an operation gating controller 815 and exchanges coordination signals with an external executive core subsystem. In some embodiments, the executive core may generate advisory requests for pulse modulation based on strategic goals, workload prioritization, or detected instability. Such requests are transmitted via the executive core interface 825 to a subsystem demand aggregator 860 for aggregation and subsequent evaluation by pulse regulation mechanisms.

A thought cache coordinator 830 gates thought cache operations based on current pulse band authorization. The coordinator 830 may permit lightweight retrieval or association operations during fast pulse intervals, re-ranking or recombination of cached content during medium pulse intervals, and consolidation, pruning, or generalization operations during slow pulse intervals. Pulse-gated access to the thought cache supports reduction of excessive memory churn and preservation of semantic coherence across cognitive time.

A sleep manager coordinator 835 provides timing coordination for sleep-like cognitive states by interfacing with a sleep manager subsystem. Entry into a sleep state may correspond to suppression of fast and medium pulse bands and activation of slow pulse bands with extended duty cycles or refractory intervals. The coordinator 835 transmits gating signals or state indicators reflecting sleep depth or consolidation phase based on pulse cadence and temporal control parameters.

A reasoning engine arbitrator 840 regulates invocation of one or more reasoning engines based on pulse band authorization and temporal context. In a non-limiting arrangement, the arbitrator 840 may authorize lightweight language generation or reactive inference during fast pulse intervals, structured reasoning during medium pulse intervals, and deeper reflective or analytical processes during slow pulse intervals. Pulse-based arbitration supports appropriate allocation of computational resources to reasoning processes without reliance on fixed scheduling cycles.

An embedding pipeline synchronizer 845 gates projection of vector-space representations into a cognitive manifold based on pulse timing and authorization. The synchronizer 845 coordinates embedding updates to occur during designated pulse intervals, thereby reducing risk of partial, inconsistent, or unsynchronized projections that could otherwise arise in long-running or distributed execution environments.

A persistence layer coordinator 850 coordinates with a persistence layer to determine safe points for checkpointing or state capture. The coordinator 850 may schedule persistence operations during specific pulse phases or following stabilization events indicated by reduced field-energy variation or other stability metrics. Alignment of persistence operations with pulse boundaries supports capture of coherent cognitive state snapshots.

A security enforcement interface 855 uses temporal pulses as enforcement boundaries for security and policy checks. The interface 855 may restrict certain operations to specific pulse bands or phases, enabling temporal compartmentalization of sensitive actions. In some embodiments, external communication may be suppressed during consolidation pulses, or policy evaluation may be enforced prior to advancement of cognitive time.

A subsystem demand aggregator 860 collects control-oriented demand signals from subsystem interface components indicating when connected subsystems require changes to temporal pulse behavior. Demand signals may arise, by way of example, from increased computational load in reasoning engines, pending consolidation requirements in a thought cache, checkpointing needs in a persistence layer, or strategic directives from an executive core. Aggregated demand information flows from the subsystem demand aggregator 860 to a modulation request generator 820.

A modulation request generator 820 produces modulation requests that are transmitted to a closed-loop control system 120. Modulation requests communicate aggregated subsystem demands for adjustments to pulse frequency, pulse band activation, duty cycle parameters, or other temporal control characteristics. The generator 820 formats demand information into requests compatible with a control interface of a closed-loop control system 120, where such requests may be evaluated alongside stability metrics, pathology indicators, and hardware constraints rather than directly overriding pulse generation behavior.

In an embodiment, data flow through a subsystem integration layer 135 proceeds as follows. Stability metrics are received from a closed-loop control system 120 and provided to a stability metrics receiver 805, while pulse band status information is received from a temporal pulse generator 115 and provided to a pulse band status receiver 810. Both sets of information flow to an operation gating controller 815, which evaluates authorization conditions and generates gating signals distributed to an executive core interface 825, a thought cache coordinator 830, a sleep manager coordinator 835, a reasoning engine arbitrator 840, an embedding pipeline synchronizer 845, a persistence layer coordinator 850, and a security enforcement interface 855. These interface components exchange coordination signals with external persistent cognitive machine subsystems and generate control-oriented demand signals that flow to a subsystem demand aggregator 860. Aggregated demands are transmitted from the aggregator 860 to a modulation request generator 820, which produces modulation requests that flow to a closed-loop control system 120 for incorporation into local temporal control action computation.

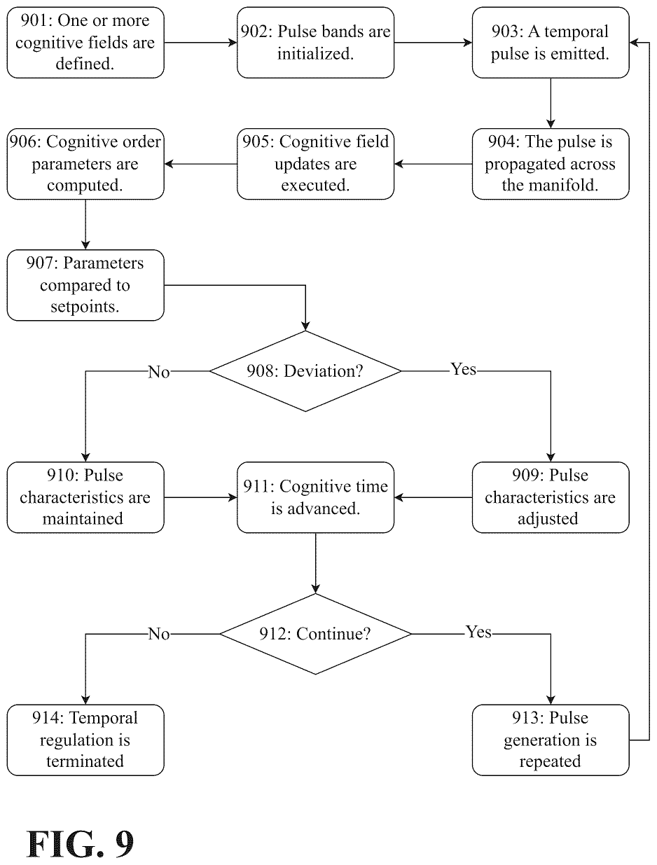

FIG. 9 is a flow diagram illustrating temporal pulse regulation of a temporal pulse regulation system 100, in an embodiment. A temporal pulse regulation system 100 governs cognitive activity in a persistent cognitive machine by generating internally controlled temporal pulses that authorize bounded execution intervals during which cognitive state evolves on a cognitive manifold. The method begins when a cognitive manifold substrate 105 defines one or more cognitive fields over a cognitive manifold represented in hardware memory, wherein each cognitive field encodes a distribution of cognitive state across positions on the cognitive manifold 901. A temporal pulse generator 115 initializes with a pulse band configuration comprising a plurality of pulse bands operating at distinct characteristic frequencies, including a fast pulse band, a medium pulse band, and a slow pulse band 902. The temporal pulse generator 115 emits a temporal pulse that authorizes a bounded execution interval during which cognitive field updates are permitted 903. The pulse is propagated across the cognitive manifold, wherein in graph-structured embodiments the propagation occurs as a wavefront traversing subsets of nodes and edges with attenuation controlled by damping coefficients 904. A field evolution engine 110 applies one or more update operators to modify field values or field relationships on the cognitive manifold during the authorized interval 905. The field evolution engine 110 computes field-energy deltas, and a closed-loop control system 120 derives cognitive order parameters from the field-energy deltas and pulse metrics, wherein the cognitive order parameters may include phase coherence, spectral entropy, or field-energy variation 906. The closed-loop control system 120 compares the computed cognitive order parameters against setpoints defining a stability corridor within which cognitive operation is considered stable and coherent 907. The system then evaluates whether a deviation from the stability corridor exists based on the comparison 908. When a deviation is detected, a control action generator 325 within the closed-loop control system 120 issues control commands to the temporal pulse generator 115 to adjust pulse characteristics, wherein the control commands may specify frequency adjustments, phase corrections, duty cycle modifications, or refractory interval parameters 909. When no deviation is detected, the closed-loop control system 120 maintains current pulse characteristics without generating corrective control commands 910. The temporal pulse regulation system 100 advances a cognitive time coordinate upon completion of the pulse, wherein the cognitive time coordinate is decoupled from wall-clock or operating system time and progresses as a function of pulse completion rather than physical time 911. The system then evaluates whether to continue cognitive operation based on system state, external directives, or termination conditions 912. When cognitive operation is to continue, the process returns to pulse emission by the temporal pulse generator 115 913. When cognitive operation is not to continue, the system terminates temporal pulse regulation 914.

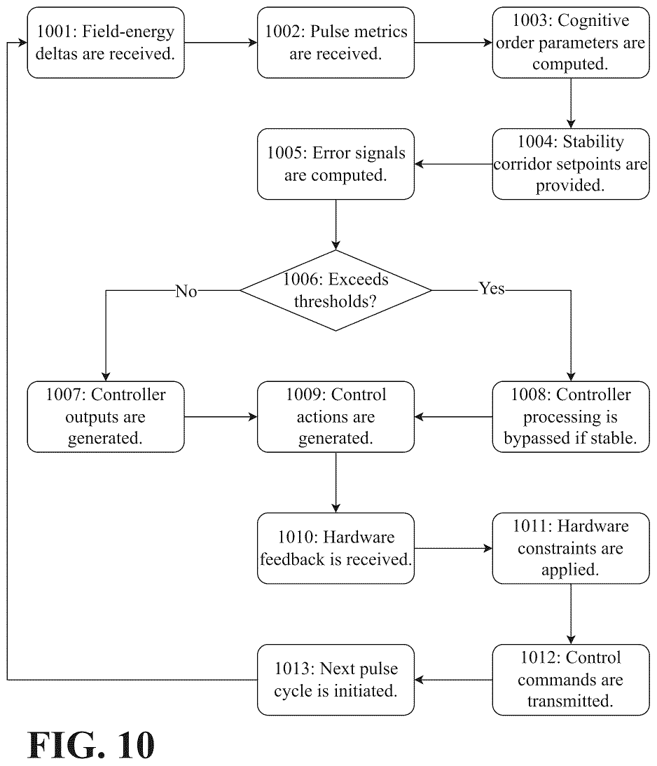

FIG. 10 is a flow diagram illustrating a closed-loop pulse regulation cycle of a closed-loop control system 120, in an embodiment. A closed-loop control system 120 continuously monitors cognitive state and adjusts pulse generation to maintain operation within a temporal stability corridor by transforming feedback derived from internal cognitive state into control actions that regulate temporal pulse characteristics. The cycle begins when a sensing and observable computation component 305 receives field-energy deltas from a field evolution engine 110, wherein the field-energy deltas indicate magnitude of change in cognitive field values resulting from the most recent pulse-authorized update interval 1001. The sensing and observable computation component 305 also receives pulse metrics from a temporal pulse generator 115, wherein the pulse metrics may include pulse timing, phase, and cadence information corresponding to one or more active pulse bands 1002. The sensing and observable computation component 305 computes cognitive order parameters from the received field-energy deltas and pulse metrics, wherein the cognitive order parameters may include, by way of example and not limitation, phase coherence measuring alignment of activity across regions of a cognitive manifold, spectral entropy measuring dispersion of activity across pulse frequencies, and field-energy variation measuring magnitude of change in cognitive fields between successive pulses 1003. A stability corridor definition component 310 provides stability corridor setpoints that define desired operating conditions in a multidimensional space of cognitive order parameters, wherein such setpoints may be predefined, adaptive, or learned over time based on workload characteristics or historical system behavior 1004. An error signal computation component 315 compares the computed cognitive order parameters against the stability corridor setpoints and computes error signals representing deviations from stable operating conditions, wherein deviations may include, for example, excessive activity indicative of incipient pulse storm, insufficient activity suggestive of starvation, or phase dispersion associated with temporal desynchronization 1005. The closed-loop control system 120 evaluates whether the computed error signals exceed one or more control thresholds, which may be defined statically or adjusted dynamically, to determine whether corrective action is warranted 1006. When error signals exceed such thresholds, a controllers component 320 processes the error signals through one or more control strategies, which may include a proportional controller 320a, a hysteretic controller 320b, a rate-limited controller 320c, and a threshold-based controller 320d, each of which may be configured to contribute to controller output based on system configuration and context 1007. When error signals do not exceed applicable thresholds, the closed-loop control system 120 bypasses controller processing and retains current pulse regulation settings 1008. A control action generator 325 generates one or more control actions based on controller outputs, wherein the control actions may include, in non-limiting embodiments, adjustments to pulse frequency, selective enabling or suppression of pulse bands, modifications to pulse duty cycles, or changes to relative phase alignment across bands or subsystems 1009. A hardware feedback integration component 330 receives hardware feedback signals from one or more hardware accelerators, wherein such signals may include, by way of example, utilization metrics, thermal status, and power consumption data 1010. The hardware feedback integration component 330 applies hardware-aware constraints to the control actions to ensure pulse regulation remains within safe operational bounds while preserving continuity of cognitive evolution 1011. The control action generator 325 transmits control commands to the temporal pulse generator 115, wherein the control commands may specify frequency adjustments, phase corrections, duty cycle modifications, or refractory interval parameters to be applied during subsequent pulse intervals 1012. The closed-loop control system 120 then returns to receiving field-energy deltas and pulse metrics for the next cycle of pulse regulation 1013.

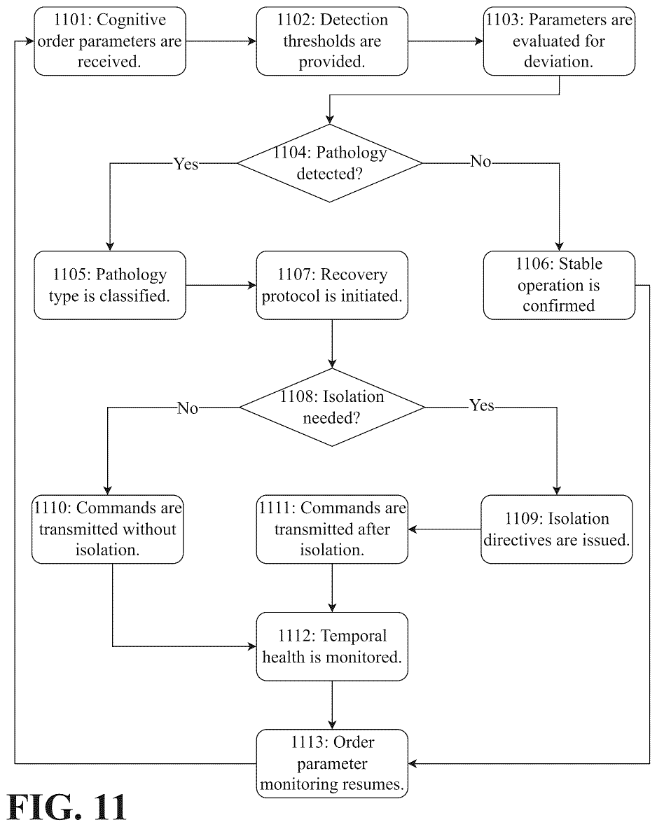

FIG. 11 is a flow diagram illustrating pathology detection and recovery of a pathology detection and recovery system 125, in an embodiment. A pathology detection and recovery system 125 identifies temporal failure modes that degrade cognitive coherence and initiates corrective protocols to restore stable operation within a temporal pulse regulation system 100. The process begins when a pathology detection component 405 receives cognitive order parameters from a closed-loop control system 120, wherein the cognitive order parameters may include, by way of example and not limitation, phase coherence, spectral entropy, field-energy variation, and activity density measures 1101. A threshold management component 430 provides detection thresholds against which the cognitive order parameters are evaluated, wherein such thresholds may be static, adaptive, or context-dependent based on system history, workload characteristics, or operating conditions 1102. The pathology detection component 405 evaluates the cognitive order parameters against the detection thresholds to identify deviations from temporally stable behavior 1103. Based on the evaluation, the pathology detection component 405 determines whether one or more deviations satisfy criteria associated with a temporal pathology 1104. When a pathology is detected, a compound pathology detector 425 classifies the pathology type, wherein pathology types may include pulse starvation when pulse activity falls below a threshold required to sustain cognitive continuity, pulse storm when pulses are generated at excessive frequency or density, temporal desynchronization when pulse phases across regions of a cognitive manifold lose alignment, or compound pathologies in which multiple failure modes interact or cascade 1105. When no pathology is detected, the pathology detection and recovery system 125 identifies that operation remains within the temporal stability corridor and continues monitoring without initiating recovery actions 1106. A recovery protocols component 435 selects and initiates a corresponding recovery protocol based on the identified pathology type, wherein, in non-limiting embodiments, a starvation recovery component 440 may address underactivity through forced pulse injection or relaxation of refractory intervals, a storm recovery component 445 may apply rate limiting or diffusion-based damping, and a desynchronization recovery component 450 may trigger phase re-locking or synchronization pulse exchanges 1107. The pathology detection and recovery system 125 evaluates whether localized isolation is warranted for affected regions of a cognitive manifold, wherein such evaluation may be based on severity, spatial localization, or persistence of the detected pathology 1108. When isolation is warranted, an isolation and containment component 455 issues isolation directives to a cognitive manifold substrate 105 to suppress or damp pulses in affected regions while permitting continued operation in unaffected regions 1109. When isolation is not warranted, a recovery commands output 470 transmits recovery commands to a temporal pulse generator 115 without issuing isolation directives 1110. When isolation directives have been issued, the recovery commands output 470 transmits recovery commands to the temporal pulse generator 115 following issuance of the isolation directives 1111. A health monitoring component 460 monitors temporal health metrics to determine whether cognitive activity returns to within the temporal stability corridor and, in some embodiments, retains historical pathology data to inform future threshold adjustment or recovery tuning 1112. The pathology detection and recovery system 125 then returns to receiving cognitive order parameters from the closed-loop control system 120 for continued monitoring and detection 1113.

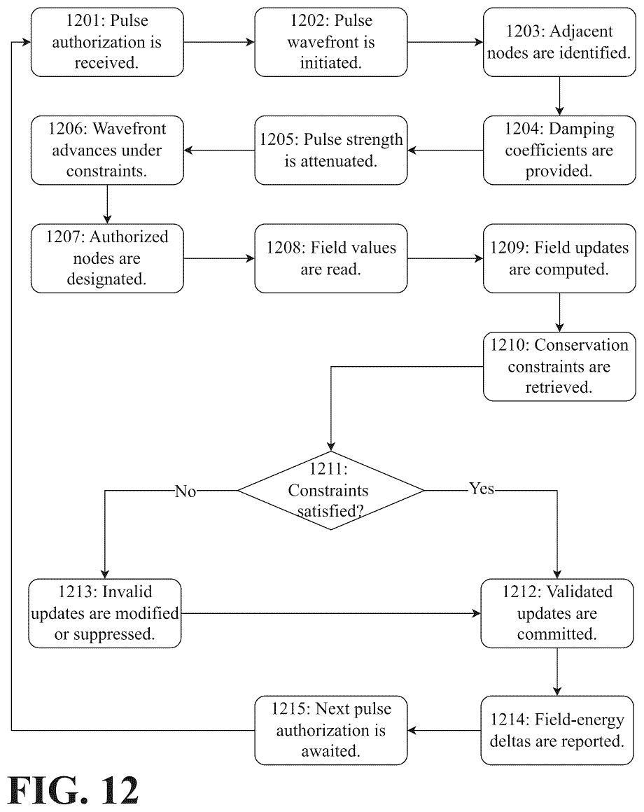

FIG. 12 is a flow diagram illustrating pulse-gated field evolution on a graph-structured cognitive manifold of a temporal pulse regulation system 100, in an embodiment. A temporal pulse regulation system 100 executes cognitive field updates as discrete computational steps corresponding to temporal pulses, wherein pulses propagate as wavefronts across a graph-structured cognitive manifold and authorize field evolution at nodes reached by the wavefront.

The process begins when an accelerator execution controller 635 of a field evolution engine 110 receives a pulse authorization signal from a temporal pulse generator 115 indicating permission to execute cognitive field updates during a bounded execution interval 1201. A graph wavefront propagation component 240 initiates a pulse wavefront at one or more designated nodes on a graph-structured cognitive manifold 505, wherein nodes correspond to localized regions of latent cognitive state 1202. The graph wavefront propagation component 240 identifies adjacent nodes reachable via edges 515 from the current wavefront position, wherein edges encode relationships such as semantic adjacency, transition likelihood, or structural affinity between nodes 1203. A graph Laplacian damping component 525 provides damping coefficients 530 that specify attenuation rates for pulse energy as it travels across edges 1204. An attenuation calculator 535 applies attenuation to pulse strength based on the damping coefficients and traversal distance from wavefront origin, thereby controlling the spatial extent and intensity of the pulse wavefront 1205. The graph wavefront propagation component 240 advances the wavefront to adjacent nodes that satisfy stability constraints 540, wherein stability constraints may limit traversal extent to prevent runaway excitation 1206. Nodes reached by the pulse wavefront 520 become authorized for field updates during the current pulse interval, while nodes not yet reached remain inactive for the pulse 1207. A field state reader 605 reads current field values from typed latent fields 545 at the authorized nodes, wherein typed latent fields include a fact field 550a, an uncertainty field 550b, and a trajectory field 550c 1208. An update operators component 610 applies one or more update operators to compute candidate updated field values, wherein update operators may include a graph Laplacian operator 615, a cross-type coupling operator 620, a neighborhood aggregation operator 625, or a spectral analysis operator 630 1209. A conservation enforcement component 645 validates candidate updated field values against one or more conservation constraints, wherein conservation constraints may include preservation of invariants, maintenance of anchor relationships, or bounds on total field mass or energy 1210. The conservation enforcement component 645 evaluates whether the candidate updates satisfy the conservation constraints 1211. When candidate updates satisfy conservation constraints, a field commit handler 650 commits the validated field updates to a cognitive manifold substrate 105 1212. When candidate updates do not satisfy conservation constraints, the conservation enforcement component 645 suppresses or modifies the updates to satisfy the conservation constraints prior to commitment 1213. A completion reporter 655 reports field-energy deltas representing magnitude of change between pre-update and post-update field values and transmits completion signals to a closed-loop control system 120 1214. The field evolution engine 110 returns to receiving pulse authorization for a next pulse interval 1215.

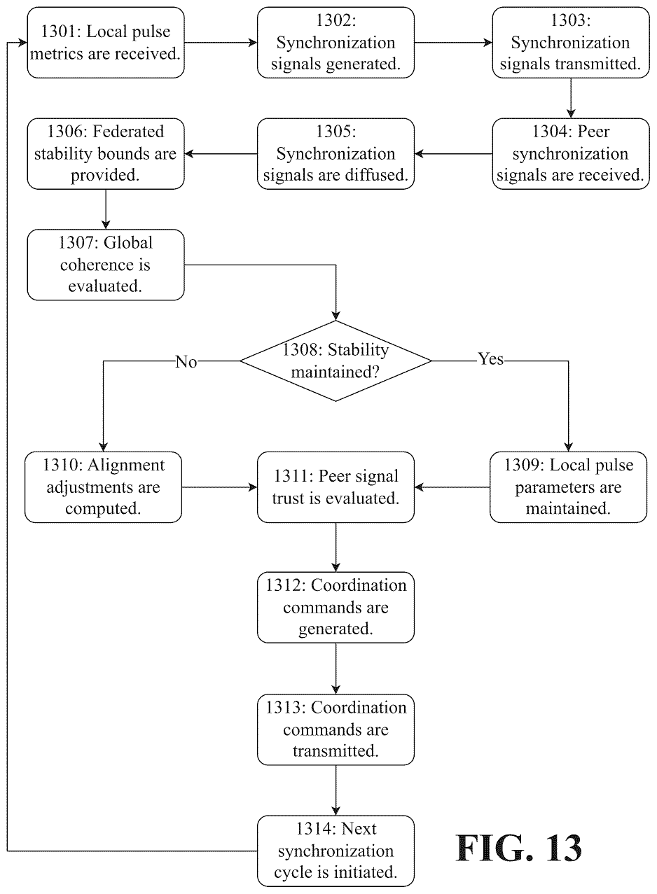

FIG. 13 is a flow diagram illustrating distributed synchronization of a distributed synchronization controller 130, in an embodiment. A distributed synchronization controller 130 coordinates temporal pulse regulation across multiple processing nodes in distributed or federated deployments, maintaining coherence of a cognitive time construct without reliance on a centralized clock. The process begins when a local pulse metrics receiver 705 receives local pulse metrics from a temporal pulse generator 115 operating on a local node, wherein the pulse metrics include pulse timing, phase, and cadence information characterizing local pulse activity 1301. A synchronization signal generator 710 generates synchronization signals that summarize local temporal state, wherein the synchronization signals may include pulse phase indicators, pulse cadence summaries, or field-energy proxies derived from cognitive activity measures 1302. A peer signal exchange 715 transmits the synchronization signals to peer nodes 101a-n in a distributed configuration 1303. The peer signal exchange 715 receives inbound synchronization signals from the peer nodes 101a-n 1304. A pulse diffusion component 720 applies pulse diffusion to integrate the received synchronization signals gradually using diffusion-like mechanisms that avoid abrupt synchronization corrections and support smooth convergence of temporal behavior across nodes 1305. A federated stability corridor manager 725 provides federated stability corridor bounds that define global coherence conditions complementing local stability corridors maintained by individual nodes 1306. The federated stability corridor manager 725 compares local and received synchronization signals against the federated stability corridor bounds to evaluate whether distributed temporal behavior satisfies global coherence conditions 1307. The distributed synchronization controller 130 evaluates whether federated stability is maintained based on the comparison 1308. When federated stability is maintained, an asynchronous alignment controller 735 maintains current local pulse parameters without computing corrective adjustments 1309. When federated stability is not maintained, the asynchronous alignment controller 735 computes alignment adjustments for local pulse behavior to restore federated coherence 1310. A fault tolerance handler 730 evaluates trust weights for peer synchronization signals based on factors such as historical consistency, behavioral stability, or quorum agreement, and reduces or suppresses influence of outlier pulse behavior indicative of faulty or adversarial nodes 1311. A coordination command generator 740 generates coordination commands incorporating the trust-weighted adjustments, wherein the coordination commands may specify adjustments to pulse frequency, phase alignment, or duty cycle parameters 1312. The coordination command generator 740 transmits the coordination commands to a closed-loop control system 120 operating on the local node for incorporation into local control action computation 1313. The distributed synchronization controller 130 returns to receiving local pulse metrics for a next synchronization cycle 1314.

### Exemplary Computing Environment

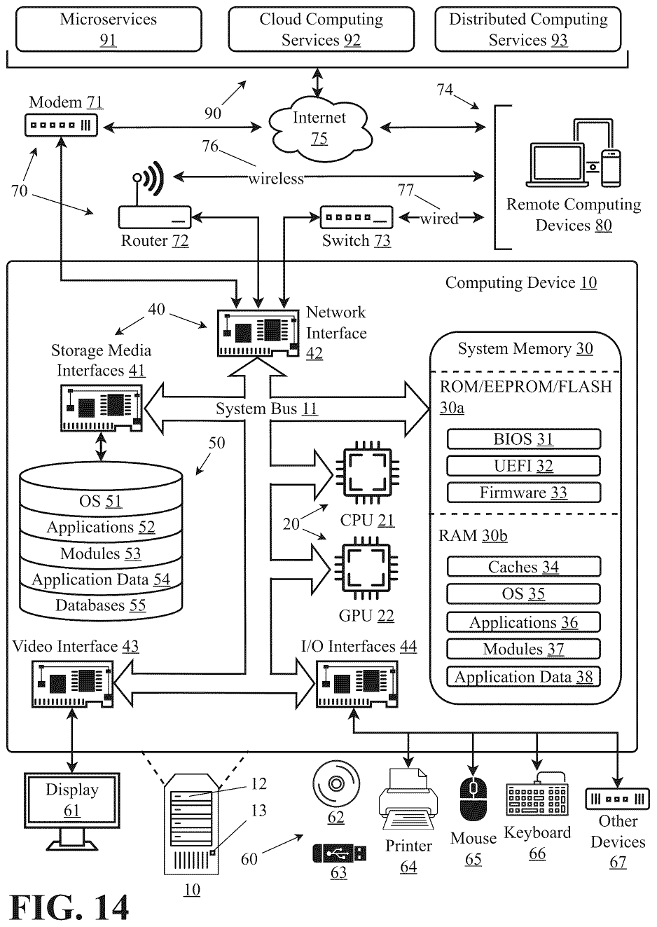

FIG. 14 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system.

Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are predefined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system configured to execute software instructions stored on nontransitory machine-readable storage media, wherein the software instructions comprise instructions that:
define one or more cognitive fields over a cognitive manifold represented in hardware memory, wherein each cognitive field encodes a distribution of cognitive state across positions on the cognitive manifold;
generate temporal pulses that authorize bounded execution intervals during which cognitive field updates are permitted to be performed, wherein each temporal pulse corresponds to a discrete evolution step that advances the one or more cognitive fields on the cognitive manifold;
regulate generation of the temporal pulses using a closed-loop control system that monitors one or more cognitive order parameters derived from the cognitive fields and adjusts one or more pulse characteristics based on deviations from a stability corridor defined in a space of the cognitive order parameters; and
execute cognitive field updates during authorized temporal pulse intervals by applying one or more update operators that modify field values or field relationships on the cognitive manifold, wherein completion of each temporal pulse advances a cognitive time coordinate that is decoupled from wall-clock or operating system time.

2. The computer system of claim 1, wherein the temporal pulses are organized into a plurality of pulse bands operating at distinct characteristic frequencies, wherein each pulse band serves a different cognitive function and the pulse bands operate hierarchically with higher-frequency bands nested within lower-frequency bands.

3. The computer system of claim 2, wherein the cognitive order parameters monitored by the closed-loop control system include at least one of phase coherence measuring alignment of activity across regions of the cognitive manifold, spectral entropy measuring dispersion of activity across the characteristic frequencies of the pulse bands, or field-energy variation measuring magnitude of change in the cognitive fields between successive pulses.

4. The computer system of claim 1, wherein the closed-loop control system detects temporal pathologies including pulse starvation when pulse activity falls below a threshold required to sustain cognitive continuity, pulse storm when pulses are generated at excessive frequency, or temporal desynchronization when pulse phases across regions of the cognitive manifold lose alignment, and initiates recovery protocols to restore stable operation.

5. The computer system of claim 1, wherein the cognitive manifold is represented as a graph structure comprising nodes corresponding to localized regions of cognitive state and edges encoding relationships between the regions, and wherein each temporal pulse propagates as a wavefront across a subset of nodes and edges with attenuation controlled by damping coefficients.

6. The computer system of claim 1, wherein the update operators are executed on one or more hardware accelerators, and wherein each temporal pulse corresponds to a bounded execution interval during which accelerator kernels are launched, such that kernel completion constitutes pulse completion and successive kernel launches advance the cognitive time coordinate.

7. The computer system of claim 6, wherein the closed-loop control system incorporates hardware feedback signals including utilization metrics or thermal status from the hardware accelerators and adjusts pulse characteristics to maintain hardware safety while preserving cognitive continuity.

8. The computer system of claim 1, wherein the computer system operates as one node in a distributed configuration comprising a plurality of nodes, each node maintaining local pulse regulation based on local cognitive state while exchanging synchronization signals with other nodes, wherein the synchronization signals include pulse phase indicators or field-energy proxies that enable federated alignment of the cognitive time coordinate without a centralized clock.

9. The computer system of claim 1, wherein the software instructions further comprise instructions that enforce a refractory interval defining a minimum separation between successive pulses to prevent excessive pulse generation and allow the cognitive fields to stabilize between updates.

10. A method for temporal pulse regulation in a cognitive system, the method comprising:
defining, by a computer system, one or more cognitive fields over a cognitive manifold represented in hardware memory, wherein each cognitive field encodes a distribution of cognitive state across positions on the cognitive manifold;
generating temporal pulses that authorize bounded execution intervals during which cognitive field updates are permitted to be performed, wherein each temporal pulse corresponds to a discrete evolution step that advances the one or more cognitive fields on the cognitive manifold;
regulating generation of the temporal pulses using a closed-loop control system that monitors one or more cognitive order parameters derived from the cognitive fields and adjusts one or more pulse characteristics based on deviations from a stability corridor defined in a space of the cognitive order parameters; and
executing cognitive field updates during authorized temporal pulse intervals by applying one or more update operators that modify field values or field relationships on the cognitive manifold, wherein completion of each temporal pulse advances a cognitive time coordinate that is decoupled from wall-clock or operating system time.

11. The method of claim 10, wherein the temporal pulses are organized into a plurality of pulse bands operating at distinct characteristic frequencies, wherein each pulse band serves a different cognitive function and the pulse bands operate hierarchically with higher-frequency bands nested within lower-frequency bands.

12. The method of claim 11, wherein the cognitive order parameters monitored by the closed-loop control system include at least one of phase coherence measuring alignment of activity across regions of the cognitive manifold, spectral entropy measuring dispersion of activity across the characteristic frequencies of the pulse bands, or field-energy variation measuring magnitude of change in the cognitive fields between successive pulses.

13. The method of claim 10, further comprising detecting temporal pathologies including pulse starvation when pulse activity falls below a threshold required to sustain cognitive continuity, pulse storm when pulses are generated at excessive frequency, or temporal desynchronization when pulse phases across regions of the cognitive manifold lose alignment, and initiating recovery protocols to restore stable operation.

14. The method of claim 10, wherein the cognitive manifold is represented as a graph structure comprising nodes corresponding to localized regions of cognitive state and edges encoding relationships between the regions, and wherein each temporal pulse propagates as a wavefront across a subset of nodes and edges with attenuation controlled by damping coefficients.

15. The method of claim 10, wherein the update operators are executed on one or more hardware accelerators, and wherein each temporal pulse corresponds to a bounded execution interval during which accelerator kernels are launched, such that kernel completion constitutes pulse completion and successive kernel launches advance the cognitive time coordinate.

16. The method of claim 15, further comprising incorporating hardware feedback signals including utilization metrics or thermal status from the hardware accelerators into the closed-loop control system and adjusting pulse characteristics to maintain hardware safety while preserving cognitive continuity.

17. The method of claim 10, wherein the computer system operates as one node in a distributed configuration comprising a plurality of nodes, the method further comprising maintaining local pulse regulation based on local cognitive state while exchanging synchronization signals with other nodes, wherein the synchronization signals include pulse phase indicators or field-energy proxies that enable federated alignment of the cognitive time coordinate without a centralized clock.

18. The method of claim 10, further comprising enforcing a refractory interval defining a minimum separation between successive pulses to prevent excessive pulse generation and allow the cognitive fields to stabilize between updates.
